(19) United States
(12) Patent Application Publication
(10) Pub. No.: US 2025/0158404 A1
(43) Pub. Date: May 15, 2025

(54) POWER MANAGEMENT SYSTEM AND POWER MANAGEMENT METHOD

(71) Applicant: Mitsubishi Electric Corporation, Tokyo (JP)

(72) Inventors: Fuyuki SATO, Tokyo (JP); Hiroki KAWANO, Tokyo (JP)

(73) Assignee: Mitsubishi Electric Corporation, Tokyo (JP)

(21) Appl. No.: 19/024,623

(22) Filed: Jan. 16, 2025

Related U.S. Application Data
(63) Continuation of application No. PCT/JP2022/040917, filed on Nov. 1, 2022.

(51) Int. Cl. H02J 3/14

(52) U.S. Cl. CPC H02J 3/14

(57) ABSTRACT

In demand control, a processor executes a normal operation of an electrical device from a start point of a demand interval. Based on a temporal change in a power consumption integrated value in execution of the normal operation, the processor determines whether or not comfort for a user in a consumer facility has been restored. From a time at which the comfort has been restored, the processor sets an execution time period of the normal operation so as to ensure a time period necessary for calculating a baseline, the baseline being a prediction value of the power consumption integrated value for a case where the normal operation is executed for an entire time period of the demand interval. When the baseline exceeds the target power by an end point of the demand interval, the processor shifts the normal operation to an energy-saving operation.

### CROSS REFERENCE TO RELATED APPLICATIONS

The present application is a continuation of International application No. PCT/JP2022/040917, filed on Nov. 1, 2022, the entire contents of which are incorporated herein by reference.

### TECHNICAL FIELD

The present disclosure relates to a power management system and a power management method.

### BACKGROUND ART

Japanese Patent Laying-Open No. 2018-26913 (PTL 1) discloses a power management system that manages power consumption in a consumer facility. The power management system is configured to execute demand control for controlling an electrical device in a consumer facility such that the amount of power used in a demand interval does not exceed target power.

The power management system disclosed in PTL 1 operates in modes including: an energy-saving mode in which energy-saving control for suppressing power consumption in an electrical device is executed; and a cancellation mode in which energy-saving control is not executed. During a specific time period elapsed since an end point of the energy-saving mode, the power management system operates in the cancellation mode. This makes it possible to restore the comfort impaired by execution of the energy-saving mode. Further, based on the information on the power usage that has been acquired during this prescribed time period, the power management system determines the amount of power usage at the end point of the demand interval as a predicted amount of power, and executes the demand control such that the predicted amount of power does not exceed the target power.

### CITATION LIST

### Patent Literature

PTL 1: Japanese Patent Laying-Open No. 2018-26913

### SUMMARY OF INVENTION

### Technical Problem

However, in the configuration including a prescribed time period during which energy-saving control is not executed within the demand interval as described above, the following problems may occur due to the length of this prescribed time period.

Specifically, as the prescribed time period is longer, the time period during which the energy-saving control is executed within the demand interval is shorter, so that the comfort can be restored, but the effect of reducing the power consumption by demand control is lessened.

In contrast, as the prescribed time period is shorter, the time period during which the energy-saving control is executed is longer, so that the effect of reducing the power consumption by demand control can be enhanced, but it becomes difficult to restore comfort. Further, when the prescribed time period is shorter, the predicted amount of power cannot be accurately determined, which leads to a concern that it may become difficult to appropriately execute the demand control.

The present disclosure has been made to solve the above-described problems, and an object thereof is to provide a power management system and a power management method by which demand control can be appropriately executed while ensuring comfort for a user of a consumer facility.

### Solution to Problem

A power management system according to one aspect of the present disclosure is a power management system to manage power consumption in a consumer facility and includes: a processor; a memory to store a program executed by the processor; and a power meter to measure power consumption in an entirety of the consumer facility. According to the program, the processor is configured to: calculate a power consumption integrated value in a demand interval based on a measurement value of the power meter; and execute demand control for controlling an electrical device in the consumer facility such that the power consumption integrated value in the demand interval does not exceed target power. In the demand control, the processor executes a normal operation of the electrical device from a start point of the demand interval. Based on a temporal change in the power consumption integrated value in execution of the normal operation, the processor determines whether or not comfort for a user of the consumer facility has been restored. From a time at which the comfort has been restored, the processor sets an execution time period of the normal operation so as to ensure a time period necessary for calculating a baseline, the baseline being a prediction value of the power consumption integrated value for a case where the normal operation is executed for an entire time period of the demand interval. When the baseline exceeds the target power by an end point of the demand interval, the processor shifts the normal operation to an energy-saving operation in which the power consumption by the electrical device is more suppressed than in the normal operation.

A power management method according to one aspect of the present disclosure is a power management method of managing power consumption in a consumer facility. The power management method includes: calculating a power consumption integrated value in a demand interval based on a measurement value of a power meter that measures power consumption in an entirety of the consumer facility; and executing demand control for controlling an electrical device in the consumer facility such that the power consumption integrated value in the demand interval does not exceed target power. The executing demand control includes: executing a normal operation of the electrical device from a start point of the demand interval; based on a temporal change in the power consumption integrated value in execution of the normal operation, determining whether or not comfort for a user of the consumer facility has been restored; from a time at which the comfort has been restored, setting an execution time period of the normal operation so as to ensure a time period necessary for calculating a baseline, the baseline being a prediction value of the power consumption integrated value for a case where the normal operation is executed for an entire time period of the demand interval; and, when the baseline exceeds the target power by an end point of the demand interval, shifting the normal operation to an energy-saving operation in which the power consumption by the electrical device is more suppressed than in the normal operation.

### Advantageous Effects of Invention

According to the present disclosure, it is possible to provide a power management system and a power management method by which demand control can be appropriately executed while ensuring comfort for a user of a consumer facility.

### BRIEF DESCRIPTION OF DRAWINGS

FIG. 1 is an overall configuration diagram of a power management system according to a first embodiment.

FIG. 2 is a diagram showing a hardware configuration of a server.

FIG. 3 is a graph showing an example of an integrated value of power consumption.

FIG. 4 is a block diagram showing a functional configuration of the power management system according to the first embodiment.

FIG. 5 is a diagram for illustrating operations of a comfort restoration determination unit and a normal operation time period calculation unit.

FIG. 6 is a flowchart illustrating an example of a process procedure for demand control by the power management system according to the first embodiment.

FIG. 7 is a diagram illustrating a determination process in an energy-saving operation execution determination unit.

FIG. 8 is a block diagram showing a functional configuration of a power management system according to a second embodiment.

FIG. 9 is a diagram for illustrating an operation of a target power achievement determination unit.

FIG. 10 is a flowchart illustrating an example of a process procedure for demand control by the power management system according to the second embodiment.

FIG. 11 is a flowchart illustrating an example of the process procedure for demand control by the power management system according to the second embodiment.

FIG. 12 is a diagram illustrating processes in S23 to S25 and S06 in FIG. 10.

FIG. 13 is a block diagram showing a functional configuration of a power management system according to a third embodiment.

FIG. 14 is a diagram for illustrating an operation of a slope ratio calculation unit.

FIG. 15 is a flowchart illustrating an example of a process procedure for demand control by the power management system according to the third embodiment.

FIG. 16 is a block diagram showing a functional configuration of a power management system according to a fourth embodiment.

FIG. 17 is a diagram for illustrating operations of a restoration time period/power calculation unit and an advance restoration determination unit.

FIG. 18 is a flowchart illustrating an example of a process procedure for demand control by the power management system according to the fourth embodiment.

FIG. 19 is a flowchart illustrating an example of the process procedure for demand control by the power management system according to the fourth embodiment.

### DESCRIPTION OF EMBODIMENTS

Hereinafter, embodiments of the present disclosure will be described in detail with reference to the accompanying drawings, in which the same or corresponding portions are denoted by the same reference characters, and the description thereof will not be repeated.

### First Embodiment

### <System Configuration>

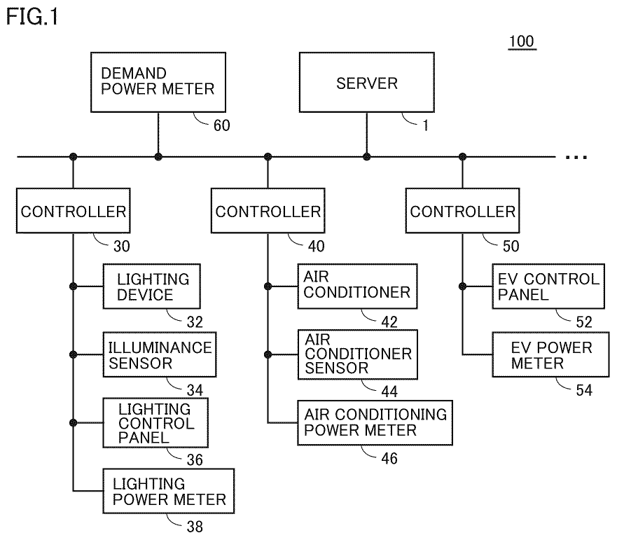

FIG. 1 is an overall configuration diagram of a power management system according to the first embodiment. A power management system 100 is a system for managing power consumption in a consumer facility. As shown in FIG. 1, power management system 100 includes controllers 30, 40, and 50, a server 1, and a demand power meter 60. Controllers 30, 40, and 50 are provided in a consumer facility. Controllers 30, 40, and 50, demand power meter 60, and server 1 exchange various signals and data with one another through a communication bus.

Controllers 30, 40, and 50 are connected to electrical devices 32, 36, 42, and 52 and various sensors 34, 38, 44, 46, and 54. Electrical devices 32, 36, 42, and 52 each are installed in a consumer facility. A consumer receives supply of electric power from an electric power supplier such as an electric power company in order to operate these electrical devices. Electrical devices 32, 36, 42, and 52 include, for example, a lighting device, a lighting control panel, an air conditioner, an elevator (EV) control panel, a sanitary device, a disaster prevention device, a security device, and the like.

In the example in FIG. 1, electrical device 32 is a lighting device, electrical device 36 is a lighting control panel, electrical device 42 is an air conditioner, and electrical device 52 is an EV control panel. Sensor 34 is an illuminance sensor, sensor 38 is a lighting power meter, sensor 44 is an air conditioner sensor, sensor 46 is an air conditioning power meter, and sensor 54 is an EV power meter.

Demand power meter 60 is a meter that measures power consumption in the entire consumer facility. Demand power meter 60 measures, as power consumption, the total value of the electric power consumed by all of the electrical devices in a consumer facility. The measured power consumption corresponds to the total power supplied from an electric power supplier to a consumer. Demand power meter 60 is installed, for example, by an electric power supplier. The information indicating the power consumption measured by demand power meter 60 is transmitted to the electric power supplier. By allowing power management system 100 to also monitor the information transmitted to the electric power supplier, the information about the power consumption can be shared between the electric power supplier and the consumer.

Each of controllers 30, 40, and 50 controls an electrical device to which each controller is connected. Further, each of controllers 30, 40, and 50 monitors a measurement value of a corresponding one of various sensors to which each controller is connected. Each of controllers 30, 40, and 50 controls a corresponding electrical device to which each controller is connected such that the corresponding electrical device is started/stopped and operated. Specifically, controller 30 is configured to be capable of adjusting the brightness of a lighting device that is electrical device 32. Controller 40 is configured to be capable of controlling a set temperature, an air flow rate and the like in an air conditioner that is electrical device 42.

Together with controllers 30, 40, and 50, server 1 manages electrical devices 32, 36, 42, and 52. Server 1 has a function as a client PC that is remotely monitored by an administrator and the like, and a function as a server that performs data storage, application processing, and the like. Server 1 performs operations, for example, for screen display and various settings.

### <Hardware Configuration>

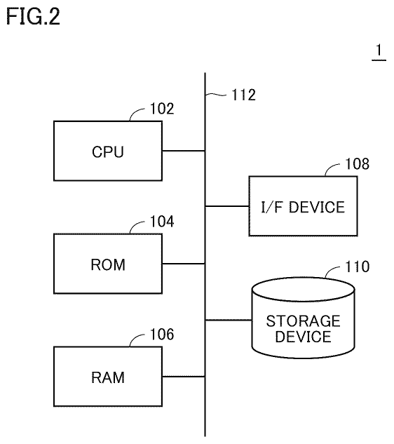

Server 1 and controllers 30, 40, and 50 each are configured mainly of a computer. FIG. 2 representatively shows a hardware configuration of server 1. As shown in FIG. 2, server 1 is configured to include a central processing unit (CPU) 102, a read only memory (ROM) 104, a random access memory (RAM) 106, an interface (I/F) device 108, and a storage device 110. CPU 102, ROM 104, RAM 106, I/F device 108, and storage device 110 exchange various pieces of data with one another through a communication bus 112.

CPU 102 deploys a program stored in ROM 104 on RAM 106 and executes the program. The program stored in ROM 104 describes processes to be executed by server 1. Note that the processes are not necessarily executed by software but can also be executed by dedicated hardware (an electronic circuit).

I/F device 108 serves as an input/output device through which signals and data are exchanged with controllers 30, 40, and 50 and demand power meter 60. I/F device 108 receives the measurement value of the power consumption in the entire consumer facility from demand power meter 60.

Storage device 110, which serves as a storage that stores various pieces of information, stores information about a consumer, information about contract power, information about electrical devices 32, 36, 42, and 52 in the consumer facility, and the like.

Although not shown, each of controllers 30, 40, and 50 is also configured to include a CPU, a ROM, a RAM, an I/F device, and a storage device. Controllers 30, 40, and 50 may be integrated with server 1.

### <Demand Control>

The following describes the operation of power management system 100 according to the first embodiment.

Power management system 100 has a demand control function as a main function for suppressing an increase in the maximum demand power in a consumer facility. The “maximum demand power” represents a maximum value in each month (for one month) among average values (demand power) of power consumption in a prescribed time period (for example, 30 minutes) called a demand interval. The maximum value of the maximum demand power in the past one year is called “contract power”. Based on this contract power, the electricity fee to be paid by a consumer to an electric power supplier is determined. Thus, suppressing the maximum demand power in the consumer facility leads to suppression of the electricity fee.

In demand control, power management system 100 controls the power consumption by electrical devices 32, 36, 42, and 52 in a consumer facility such that the average value (demand power) of the power consumption in a consumer facility in a demand interval does not exceed the contract power.

For this demand control, the integrated value of the power consumption in the entire consumer facility in the demand interval is used. For example, the measurement value of the power consumption is transmitted from demand power meter 60 to server 1 at a prescribed sampling timing (for example, a 1-minute period) in the demand interval (for 30 minutes). Assuming that power [kW] is an instantaneous value, for example, the measurement value of the power consumption is transmitted from demand power meter 60 to server 1 as average power consumption for one minute.

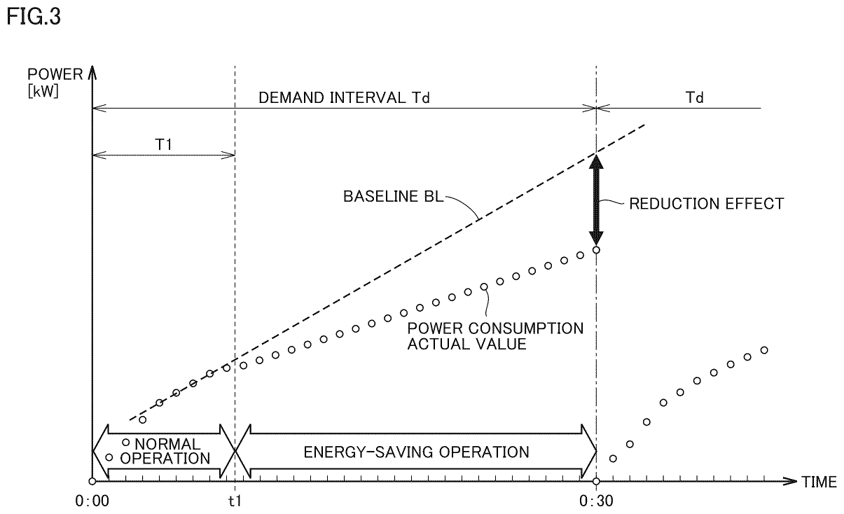

FIG. 3 is a graph showing an example of an integrated value of power consumption. The graph in FIG. 3 shows a temporal change in the integrated value of the power consumption in each demand interval Td. In the graph in FIG. 3, the vertical axis represents power [kW] and the horizontal axis represents time.

The integrated value of the power consumption is determined by integrating each measurement value of the power consumption transmitted from demand power meter 60 to server 1 at each sampling timing within demand interval Td. Each mark “∘” in the figure indicates an actual value of the integrated value of the power consumption (hereinafter also referred to as a “power consumption actual value”) determined at each sampling timing. For example, when the sampling timing is a 1-minute period and demand interval Td is 30 minutes, each data of the power consumption at up to 30 points is integrated in each demand interval Td. The maximum value of the data about the power consumption at these 30 points is defined as an integrated value (power consumption actual value) of the power consumption at an end point of demand interval Td.

Power management system 100 controls an electrical device such that the power consumption actual value at the end point of demand interval Td is equal to or less than target power in each demand interval Td. Note that the target power is set to be lower than a threshold value based on the contract power. Since whether or not the power consumption actual value is equal to or less than the target power is determined in each demand interval Td, the power consumption actual value used for this determination is reset to zero at a start point of demand interval Td.

In the demand control, power management system 100 executes an “energy-saving operation” for suppressing the power consumption by an electrical device. As an example of the energy-saving operation, electrical device 32 serving as a lighting device is controlled to lower its dimming level (brightness) or to be turned off according to the situation. As another example of the energy-saving operation, electrical device 42 serving as an air conditioner is controlled to raise the set temperature during a cooling operation, to lower the set temperature during a heating operation, to reduce the air flow rate, or to stop its operation according to the situation. The energy-saving operation is executed in a plurality of stages, and the power consumption by the electrical device can be suppressed stage by stage.

In this way, according to the demand control, execution of the energy-saving operation makes it possible to avoid the demand power from exceeding the contract power but, on the other hand, limits the operation of the electrical devices such as a lighting device and an air conditioner, thereby leading to a concern that the comfort for a user of the consumer facility may decrease.

Thus, as shown in FIG. 3, there is a prescribed time period T1 within demand interval Td, for example, a time period from the start point of demand interval Td to time t1 during which the limitation by the demand control on the power consumption by the electrical device is lifted. In this time period T1, power management system 100 does not execute the above-described energy-saving operation but executes a “normal operation”. In the normal operation, an electrical device is freely operated in response to the operation by the user of the consumer facility. Thereby, the limitation on the operation of each of the lighting device, the air conditioner, and the like is lifted, so that the user's comfort can be restored.

In addition to the above-described purpose of restoring the user's comfort, the normal operation is executed to determine a prediction value of the integrated value of the power consumption at the end point of demand interval Td (the prediction value will be hereinafter also referred to as a “power consumption prediction value”). Specifically, a baseline BL indicated by a dashed line is determined from the power consumption actual value in time period T1. For example, an approximate straight line is obtained by the least-squares method based on all the data of the power consumption actual values in time period T1. This approximate straight line is defined as baseline BL.

Baseline BL represents a prediction value of the integrated value of the power consumption (a power consumption prediction value) for the case where the energy-saving operation is not executed for the entire time period of demand interval Td. In other words, baseline BL represents the power consumption prediction value for the case where the normal operation is executed for the entire time period of demand interval Td. When the power consumption prediction value exceeds a target value by the end point of demand interval Td, the energy-saving operation is executed at and after time t1.

Further, baseline BL is used to calculate the effect of reducing the power consumption by the demand control in each demand interval Td. Specifically, the amount of power reduction resulting from execution of the demand control is calculated by subtracting the power consumption actual value at the end point of demand interval Td on baseline BL from the power consumption prediction value at this end point. The amount of power reduction represents an effect of reducing the power consumption in demand interval Td.

However, in the configuration in which prescribed time period T1 for executing the normal operation is provided within demand interval Td, the following problems may occur due to the length of time period T1.

Specifically, a longer time period T1 for execution of the normal operation leads to a shorter time period for execution of the energy-saving operation within demand interval Td. In this case, the user's comfort can be restored, whereas the effect of reducing the power consumption by the demand control is lessened.

In contrast, a shorter time period T1 for execution of the normal operation leads to a longer time period for execution of the energy-saving operation within demand interval Td. Accordingly, the effect of reducing the power consumption by the demand control can be enhanced. On the other hand, it becomes difficult to restore the user's comfort.

Further, there is a concern that a shorter time period T1 for execution of the normal operation makes it difficult to accurately determine baseline BL. Specifically, as the energy-saving operation is switched to the normal operation at the start point of demand interval Td, the power consumption by some of the electrical devices may temporarily increase. For example, in the case of an air conditioner, the power consumption temporarily increases by execution of control, for example, by increasing the cooling/heating load so as to cause the room temperature to quickly follow the change in the set temperature. As a result, the power consumption actual value determined from the measurement value of demand power meter 60 also sharply increases at and after the start point of demand interval Td. In the case where time period T1 for execution of the normal operation is short, baseline BL is determined using this temporarily increased power consumption actual value. Thus, the determined baseline BL is higher in value than the power consumption prediction value for the case where the normal operation is executed for the entire time period of demand interval Td. This makes it difficult to accurately calculate the amount of power reduction resulting from execution of the demand control.

In the prior art, time period T1 for execution of the normal operation within demand interval Td is set as a predetermined fixed time period, and there is no mentioning of the above-described problems.

Thus, power management system 100 according to the first embodiment variably sets the length of time period T1 for execution of a normal operation within demand interval Td so as to restore the user's comfort and to ensure the time period for calculating baseline BL.

### <Functional Configuration>

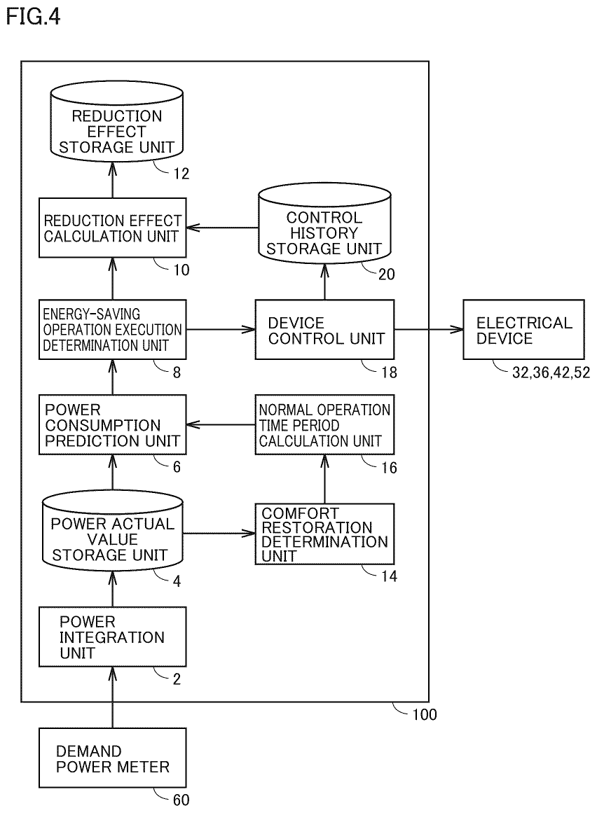

FIG. 4 is a block diagram showing a functional configuration of power management system 100 according to the first embodiment. As shown in FIG. 4, power management system 100 includes a power integration unit 2, a power actual value storage unit 4, a power consumption prediction unit 6, an energy-saving operation execution determination unit 8, a reduction effect calculation unit 10, a reduction effect storage unit 12, a device control unit 18, and a control history storage unit 20. Each of these functions is implemented, for example, by the CPU of each of server 1 and controllers 30, 40, and 50 executing a program stored in the ROM. Some or all of these functions may be implemented by hardware.

Power integration unit 2 acquires the measurement value of the power consumption in a consumer facility from demand power meter 60 at each sampling timing within demand interval Td. Power integration unit 2 integrates each measurement value of the power consumption within demand interval Td. As described above, when the sampling timing is a 1-minute period and demand interval Td is 30 minutes, power integration unit 2 integrates each data of the power consumption at up to 30 points in each demand interval Td.

Power actual value storage unit 4 stores an actual value (a power consumption actual value) of the integrated value of the power consumption within demand interval Td that has been calculated by power integration unit 2. As shown in FIG. 3, the power consumption actual value within demand interval Td is obtained by integrating the data of the power consumption in the normal operation and the data of the power consumption in the energy-saving operation.

Power consumption prediction unit 6 calculates baseline BL based on the power consumption actual value obtained during the normal operation and stored in power actual value storage unit 4. As described with reference to FIG. 3, baseline BL represents the power consumption prediction value for the case where the normal operation is executed for the entire time period of demand interval Td.

Energy-saving operation execution determination unit 8 compares baseline BL calculated by power consumption prediction unit 6 with predetermined target power for the demand control. Then, based on the comparison result, energy-saving operation execution determination unit 8 determines whether or not to execute the energy-saving operation at and after the end time of the normal operation.

Specifically, when the power consumption prediction value represented by baseline BL exceeds the target power by the end point of demand interval Td, energy-saving operation execution determination unit 8 determines to execute the energy-saving operation. On the other hand, when the power consumption prediction value does not exceed the target power by the end point of demand interval Td, energy-saving operation execution determination unit 8 determines not to execute the energy-saving operation.

Device control unit 18 controls the power consumption by each of electrical devices 32, 36, 42, and 52 based on the result of determination by energy-saving operation execution determination unit 8 as to whether the energy-saving operation can be executed or not. When the energy-saving operation is executed, device control unit 18 suppresses the power consumption in the electrical device. On the other hand, when the energy-saving operation is not executed, device control unit 18 executes the normal operation. In this case, device control unit 18 controls the operation of each electrical device according to the operation by the user of the consumer facility.

Control history storage unit 20 stores the details about control for an electrical device by device control unit 18.

Reduction effect calculation unit 10 calculates the effect of reducing the power consumption by the demand control in each demand interval Td. Specifically, reduction effect calculation unit 10 calculates the amount of power reduction resulting from the execution of the demand control by subtracting the power consumption actual value at the end point of demand interval Td on baseline BL from the power consumption prediction value at this end point.

Reduction effect storage unit 12 stores the amount of power reduction calculated in each demand interval Td by reduction effect calculation unit 10.

Power management system 100 further includes a comfort restoration determination unit 14 and a normal operation time period calculation unit 16 each as a configuration for variably setting the execution time period of the normal operation within demand interval Td.

During the execution of the normal operation, comfort restoration determination unit 14 determines whether or not the user's comfort has been restored based on the temporal change in the power consumption actual value. Normal operation time period calculation unit 16 calculates the execution time period of the normal operation based on the result of determination by comfort restoration determination unit 14.

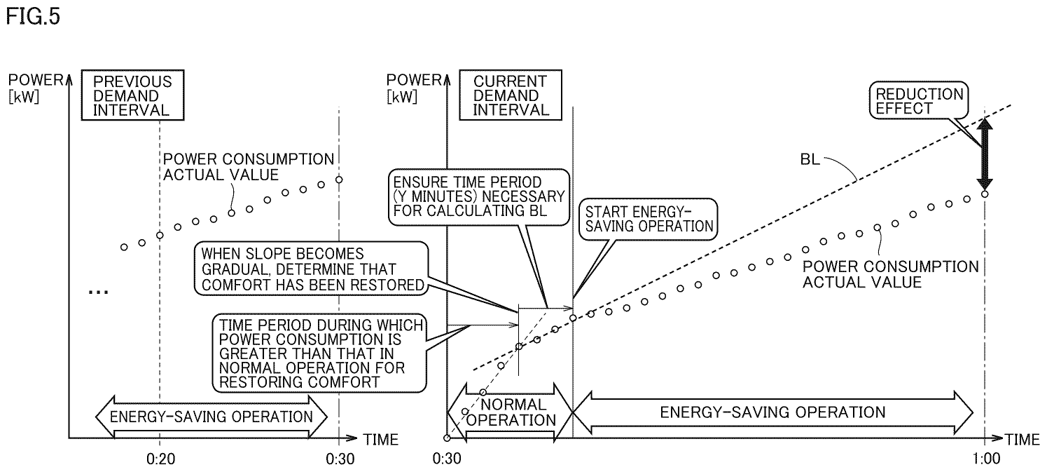

FIG. 5 is a diagram for illustrating the operations of comfort restoration determination unit 14 and normal operation time period calculation unit 16. FIG. 5 illustrates a change in the integrated value of the power consumption in each of a previous demand interval Td and a current demand interval Td. In the graph in FIG. 5, the vertical axis represents power [kW] and the horizontal axis represents time.

In the example in FIG. 5, the energy-saving operation is executed in previous demand interval Td. During the energy-saving operation, the operation of each of the electrical devices including an air conditioner is limited, so that the user's comfort decreases.

In response to the start of current demand interval Td, the normal operation is executed. In the normal operation immediately after the energy-saving operation is switched to the normal operation, the electrical device is controlled so as to restore the comfort that has been decreased by the immediately preceding energy-saving operation.

For example, in the air conditioner, in response to switching to the normal operation, the set temperature is set back to the temperature based on the user's operation. The operation of the air conditioner is controlled such that the indoor temperature immediately follows such a transient change in the set temperature. During this time period, the air conditioning load increases, so that the power consumption by the air conditioner increases. Then, by the operation of the air conditioner, the indoor temperature gradually approaches the set temperature, the deviation of the indoor temperature from the set temperature decreases, and accordingly, the air conditioning load decreases. As the air conditioning load decreases, the power consumption by the air conditioner also decreases.

In this way, immediately after the energy-saving operation is switched to the normal operation, the control for restoring the user's comfort is executed, so that the power consumption actual value sharply increases. Then, as the comfort is restored, the increase in the power consumption actual value slows down.

Based on the temporal change in the power consumption actual value in execution of the normal operation, comfort restoration determination unit 14 determines whether or not the user's comfort has been restored. As shown in FIG. 5, comfort restoration determination unit 14 determines an approximate straight line by linearly approximating, by the least-squares method, the data of the power consumption actual values obtained at and after the start point of current demand interval Td. The slope of this approximate straight line represents a temporal change rate of the power consumption actual value.

As described above, immediately after the energy-saving operation is switched to the normal operation, the load on the electrical device increases in order to recover the user's comfort, and thus, the power consumption actual value also sharply increases. Therefore, the slope of the approximate straight line (i.e., the temporal change rate of the power consumption actual value) also increases. As the load on the electrical device gradually decreases during the execution of the normal operation, the increase in the power consumption actual value slows down, so that the slope of the approximate straight line becomes gradual.

Comfort restoration determination unit 14 monitors the slope of the approximate straight line during execution of the normal operation at and after the start point of demand interval Td. In response to the state in which the slope of the approximate straight line becomes gradual, comfort restoration determination unit 14 determines that the user's comfort has been restored. Based on the slope of the approximate straight line, comfort restoration determination unit 14 further specifies the time at which the comfort has been restored.

In response to the determination by comfort restoration determination unit 14 that the user's comfort has been restored, normal operation time period calculation unit 16 sets the end time of the normal operation that is being executed. This is for the purpose of determining baseline BL from the power consumption actual value in the execution time period of the normal operation at and after the time at which the comfort has been restored. The slope of baseline BL determined from the power consumption actual value from the start point of demand interval Td to the time at which the comfort is restored is steeper than the slope of baseline BL determined from the power consumption actual value obtained after the comfort is restored. By determining baseline BL from the power consumption actual value in the normal operation at and after the time at which the comfort has been restored, it is possible to avoid deviation of baseline BL from the power consumption prediction value for the case where the normal operation is continuously executed also at and after the time at which the comfort has been restored.

Normal operation time period calculation unit 16 sets the end time of the normal operation such that a time period for acquiring the required number of power consumption actual values for calculating baseline BL is ensured between the time at which the comfort has been restored and the end time of the normal operation.

Specifically, the execution time period of the normal operation corresponds to a time period from the start point of demand interval Td to the end time set by normal operation time period calculation unit 16. This time period corresponds to the sum of: the execution time period of the normal operation for restoring the user's comfort; and the execution time period of the normal operation necessary for calculating baseline BL. In this way, comfort restoration determination unit 14 and normal operation time period calculation unit 16 variably set the execution time period of the normal operation according to the temporal change in the power consumption actual value in execution of the normal operation.

### <Process Flow>

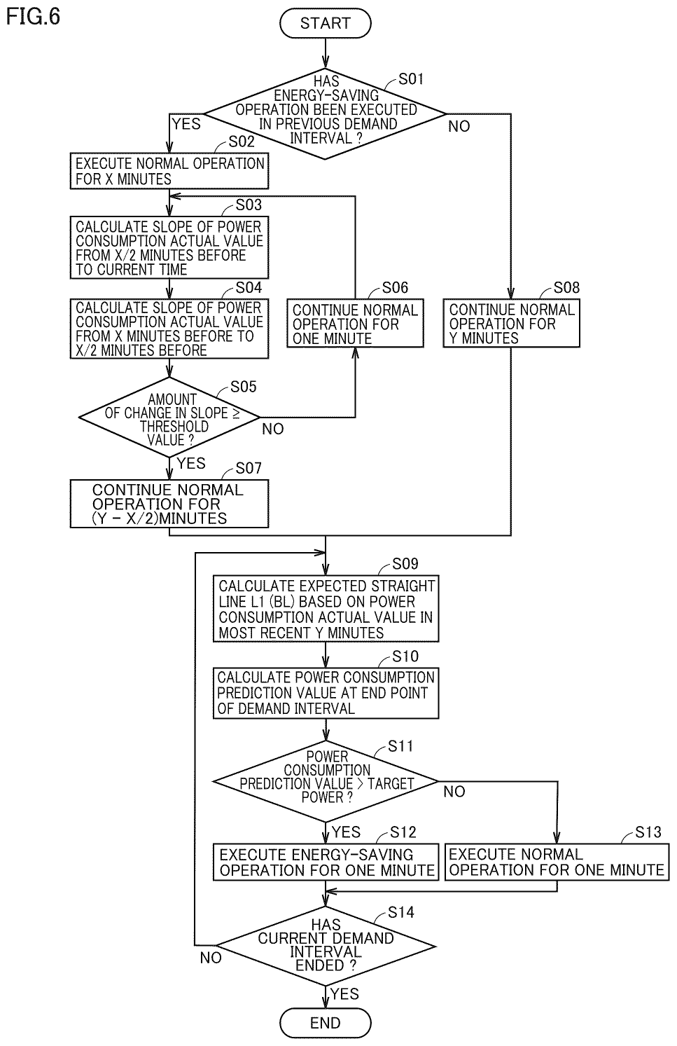

FIG. 6 is a flowchart illustrating an example of a process procedure for demand control by power management system 100 according to the first embodiment. The process shown in the flowchart in FIG. 6 is repeatedly performed by server 1 and controllers 30, 40, and 50 in each demand interval Td. Therefore, the start point (start) of the flowchart corresponds to the start point of demand interval Td.

Each step in the flowchart in FIG. 6 is implemented by software processing by server 1 and controllers 30, 40, and 50, but may be implemented by hardware (an electrical circuit) disposed in server 1 or controllers 30, 40, 50. Hereinafter, each step is abbreviated as S.

Referring to FIG. 6, when counting of current demand interval Td is started, device control unit 18 first determines whether or not the energy-saving operation has been executed in previous demand interval Td (S01). In S01, device control unit 18 refers to the details about control for an electrical device in previous demand interval Td that are stored in control history storage unit 20 to determine whether or not the energy-saving operation has been executed.

When the energy-saving operation has been executed in previous demand interval Td (determined as YES in S01), device control unit 18 executes the normal operation of the electrical device for a predetermined time period (for X minutes) (S02). This X minutes corresponds to the time period necessary for the process of determining whether or not the user's comfort has been restored. Note that X minutes is set to have a length of an even multiple of the sampling timing (a 1-minute period).

During the execution of the normal operation, power integration unit 2 acquires the measurement value of the power consumption in the consumer facility from demand power meter 60 at each sampling timing. Power integration unit 2 integrates the acquired measurement values to calculate a power consumption actual value within demand interval Td. Power actual value storage unit 4 stores the power consumption actual value within demand interval Td.

Comfort restoration determination unit 14 determines whether or not the user's comfort has been restored, based on the power consumption actual value in execution of the normal operation that is stored in power actual value storage unit 4.

Specifically, first, comfort restoration determination unit 14 linearly approximates the power consumption actual values for a time period (X/2 minutes) from X/2 minutes before to the current time, and then, calculates the slope of the obtained approximate straight line (S03). Further, comfort restoration determination unit 14 linearly approximates the power consumption actual values for the time period (X/2 minutes) from X minutes before to X/2 minutes before, and then, calculates the slope of the obtained approximate curve (S04).

Then, comfort restoration determination unit 14 calculates the amount of change between: the slope of the approximate straight line in the time period from X/2 minutes before to the current time that has been calculated in S03; and the slope of the approximate straight line in the time period from X minutes before to X/2 minutes before that has been calculated in S04. Then, comfort restoration determination unit 14 compares the calculated amount of change in slope with a predetermined threshold value (S05).

When the amount of change in slope is less than the threshold value (determined as NO in S05), comfort restoration determination unit 14 determines that the user's comfort has not been restored. In this case, device control unit 18 continues to execute the normal operation for further one minute (S06). This one minute corresponds to the sampling timing of demand power meter 60. Thereafter, comfort restoration determination unit 14 performs the determination process (S03 to S05) again.

On the other hand, when the amount of change in slope is equal to or greater than the threshold value (determined as YES in S05), comfort restoration determination unit 14 determines that the user's comfort has been restored. Note that comfort restoration determination unit 14 regards the time that is X/2 minutes before the current time as time at which the comfort has been restored.

When it is determined that the comfort has been restored, device control unit 18 continues to execute the normal operation for further (Y−X/2) minutes (S07). Note that Y minutes corresponds to a time period for acquiring the required number of power consumption actual values for calculating baseline BL. In other words, Y minutes corresponds to the execution time period of the normal operation necessary for calculating baseline BL.

Continuous execution of the normal operation for (Y−X/2) minutes in S07 makes it possible to ensure that the normal operation is executed for Y minutes from the time that is X/2 minutes before the time at which the comfort has been restored. Thereby, baseline BL can be calculated by using the power consumption actual value in the normal operation after the comfort has been restored.

Returning to S01, when the energy-saving operation is not executed in previous demand interval Td (determined as NO in S01), device control unit 18 executes the normal operation of the electrical device for Y minutes (S08). As described above, Y minutes corresponds to the execution time period of the normal operation necessary for calculating baseline BL. When the energy-saving operation is not executed in previous demand interval Td, the user's comfort does not decrease. Thus, the control for restoring the comfort is not executed during execution of the normal operation. Therefore, there is almost no change in the slope of the approximate straight line determined from the power consumption actual values at and after the start point of demand interval Td.

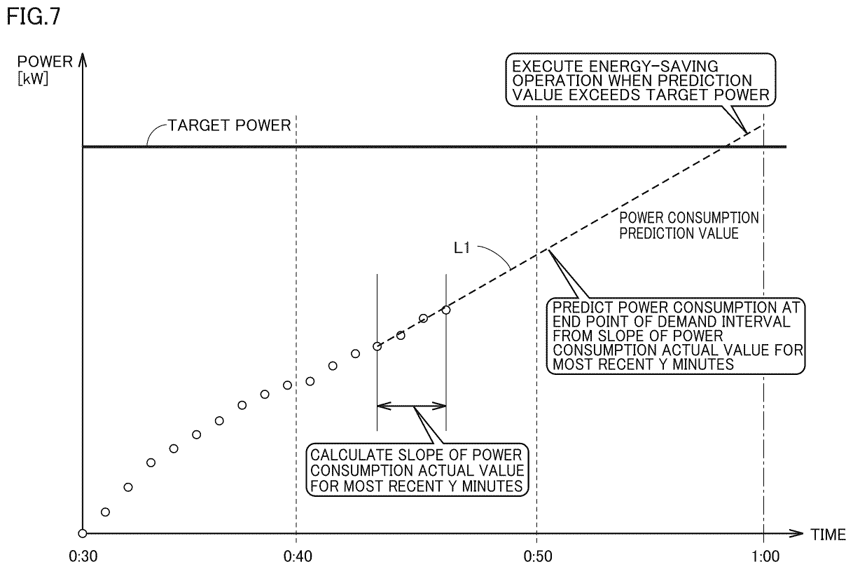

When the normal operation is executed by the processes in S01 to S08, energy-saving operation execution determination unit 8 then determines whether or not to execute the energy-saving operation at and after the current time. FIG. 7 is a diagram illustrating a determination process in energy-saving operation execution determination unit 8. FIG. 7 illustrates a change in integrated value of the power consumption in current demand interval Td. In the graph in FIG. 7, the vertical axis represents power [kW] and the horizontal axis represents time.

First, power consumption prediction unit 6 calculates an expected straight line L1 based on the power consumption actual value for the most recent Y minutes that is stored in power actual value storage unit 4 (S09). Expected straight line L1 is determined by linearly approximating the power consumption actual values for Y minutes by the least-squares method. Expected straight line L1 represents a prediction value (a power consumption prediction value) of the integrated value of the power consumption for the case where the control for the electrical device for the most recent Y minutes is continued also at and after the current time.

Expected straight line L1 calculated immediately after execution of the normal operation for Y minutes in S07 or S08 corresponds to baseline BL (see FIG. 5). In other words, expected straight line L1 represents the power consumption prediction value for the case where the normal operation is executed for the entire time period of demand interval Td.

Based on expected straight line L1 calculated in S09, energy-saving operation execution determination unit 8 determines whether or not to execute the energy-saving operation at and after the current time. Specifically, from expected straight line L1, energy-saving operation execution determination unit 8 calculates the power consumption prediction value at the end point of demand interval Td (S10). Then, energy-saving operation execution determination unit 8 compares the power consumption prediction value at the end point of demand interval Td with the target power for the demand control (S11).

When the power consumption prediction value at the end point of demand interval Td is greater than the target power (determined as YES in S11), energy-saving operation execution determination unit 8 determines to execute the energy-saving operation. In this case, device control unit 18 executes the energy-saving operation of the electrical device for one minute (S12). This one minute corresponds to the sampling timing of demand power meter 60.

On the other hand, when the power consumption prediction value at the end point of demand interval Td is equal to or less than the target power (determined as NO in S11), energy-saving operation execution determination unit 8 determines not to execute the energy-saving operation. In this case, device control unit 18 executes the normal operation of the electrical device for one minute (S13).

When the energy-saving operation or the normal operation is executed for one minute in S12 and S13, energy-saving operation execution determination unit 8 determines whether or not current demand interval Td has ended (S14). If current demand interval Td has not ended (determined as NO in S14), energy-saving operation execution determination unit 8 returns the process to S09, calculates expected straight line L1 again based on the power consumption actual value for the most recent Y minutes, and then, calculates the power consumption prediction value at the end point of demand interval Td based on the calculated expected straight line L1 (S10). Then, energy-saving operation execution determination unit 8 compares the power consumption prediction value at the end point of demand interval Td with the target power (S11) to determine the details about control for next one minute (S12 and S13). The processes in S09 to S13 are repeatedly performed until it is determined that current demand interval Td has ended (determined as YES in S14).

As described above, according to power management system 100 in the first embodiment, the execution time period of the normal operation within demand interval Td is variably set according to the temporal change in the power consumption actual value in execution of the normal operation so as to restore the user's comfort and to ensure the execution time period of the normal operation necessary for calculating baseline BL.

Thereby, power management system 100 can appropriately execute the energy-saving operation based on the power consumption prediction value calculated from baseline BL without impairing the user's comfort. As a result, the effect of reducing the power consumption by the demand control can be achieved while ensuring the user's comfort.

In the first embodiment, the execution time period of the normal operation can be set using only the temporal change in the power consumption actual value in execution of the normal operation, which makes it possible to facilitate application to the existing power management system.

### Second Embodiment

As described in the first embodiment, executing the normal operation within demand interval Td makes it possible to restore the comfort that has been decreased by execution of the immediately preceding energy-saving operation. Further, it is possible to calculate the power consumption prediction value (baseline BL) for the case where the normal operation is executed for the entire time period within demand interval Td. Then, in the case where this power consumption prediction value exceeds the target power, shifting from the normal operation to the energy-saving operation makes it possible to set the power consumption actual value within demand interval Td to be equal to or less than the target power.

On the other hand, however, by setting the execution time period of the normal operation within demand interval Td, execution of the energy-saving operation from the end time of the normal operation to the end point of demand interval Td may also lead to a situation in which the power consumption actual value within demand interval Td exceeds the target power.

Thus, the second embodiment will be described with regard to a configuration for more reliably setting the power consumption actual value within demand interval Td to be equal to or less than a target value.

### <Functional Configuration>

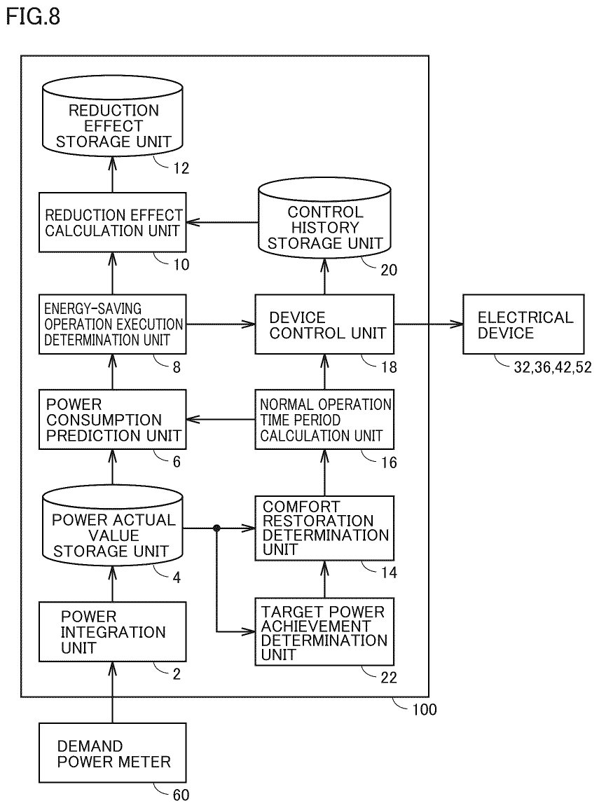

FIG. 8 is a block diagram showing a functional configuration of power management system 100 according to the second embodiment. Power management system 100 shown in FIG. 8 is obtained by adding a target power achievement determination unit 22 to power management system 100 shown in FIG. 4.

Based on the power consumption actual value within previous demand interval Td that is stored in power actual value storage unit 4, target power achievement determination unit 22 determines whether or not the integrated value of the power consumption can be set to be equal to or less than the target power even when the normal operation is executed in current demand interval Td. When target power achievement determination unit 22 determines that the integrated value of the power consumption may exceed the target power due to execution of the normal operation, it limits the execution time period of the normal operation such that the integrated value of the power consumption is set to be equal to or less than the target power. Such limitation on the execution time period of the normal operation includes setting the execution time period of the normal operation at 0 minute (not executing the normal operation).

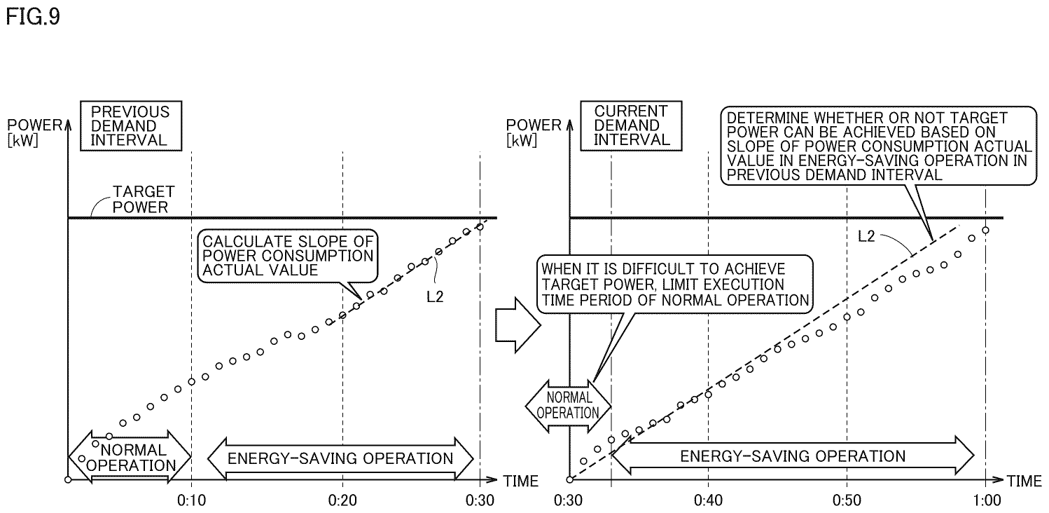

FIG. 9 is a diagram for illustrating an operation of target power achievement determination unit 22. FIG. 9 illustrates a change in the integrated value of the power consumption in each of previous demand interval Td and current demand interval Td. In the graph in FIG. 9, the vertical axis represents power [kW] and the horizontal axis represents time.

In the example in FIG. 9, the energy-saving operation is executed in previous demand interval Td. Target power achievement determination unit 22 determines an approximate straight line L2 by linearly approximating, by the least-squares method, the power consumption actual values in the execution time period of the energy-saving operation within previous demand interval Td.

Then, target power achievement determination unit 22 applies this approximate straight line L2 to current demand interval Td. As shown in FIG. 9, approximate straight line L2 represents the prediction value of the integrated value of the power consumption for the case where the energy-saving operation is executed from the start point of demand interval Td.

When the prediction value exceeds the target power by the end point of current demand interval Td, target power achievement determination unit 22 determines that the integrated value of the power consumption may exceed the target value due to execution of the normal operation in current demand interval Td. In this case, target power achievement determination unit 22 sets the execution time period of the normal operation at 0 minute. In other words, target power achievement determination unit 22 does not execute the normal operation in current demand interval Td.

On the other hand, when the prediction value does not exceed the target power by the end point of current demand interval Td, target power achievement determination unit 22 determines that the integrated value of the power consumption can be set to be equal to or less than the target power even when the normal operation is executed. In this case, target power achievement determination unit 22 is assumed to execute the normal operation in current demand interval Td.

However, during execution of the normal operation, at each sampling timing, target power achievement determination unit 22 uses the power consumption actual value at the current time and approximate straight line L2 to calculate the power consumption prediction value for the case where the energy-saving operation is executed at and after the current time. Then, target power achievement determination unit 22 determines whether or not the calculated power consumption prediction value exceeds the target power by the end point of current demand interval Td.

When target power achievement determination unit 22 determines that the power consumption prediction value exceeds the target power by the end point of current demand interval Td, it stops the execution of the normal operation at and after the current time and shifts the operation of the electrical device to the energy-saving operation. On the other hand, when target power achievement determination unit 22 determines that the power consumption prediction value does not exceed the target power by the end point of current demand interval Td, it continues the execution of the normal operation also at and after the current time. In this case, as described in the first embodiment, comfort restoration determination unit 14 and normal operation time period calculation unit 16 set the execution time period of the normal operation so as to restore the user's comfort and to ensure the time period necessary for calculating baseline BL.

In this way, target power achievement determination unit 22 uses the temporal change in the power consumption actual value in the execution time period of the energy-saving operation within previous demand interval Td to determine the power consumption prediction value for the case where the energy-saving operation is executed in current demand interval Td. Then, target power achievement determination unit 22 limits the execution time period of the normal operation such that the power consumption prediction value is set to be equal to or less than the target power. Thereby, the execution of the normal operation is limited while the power consumption actual value within demand interval Td can be reliably set to be equal to or less than the target power.

### <Process Flow>

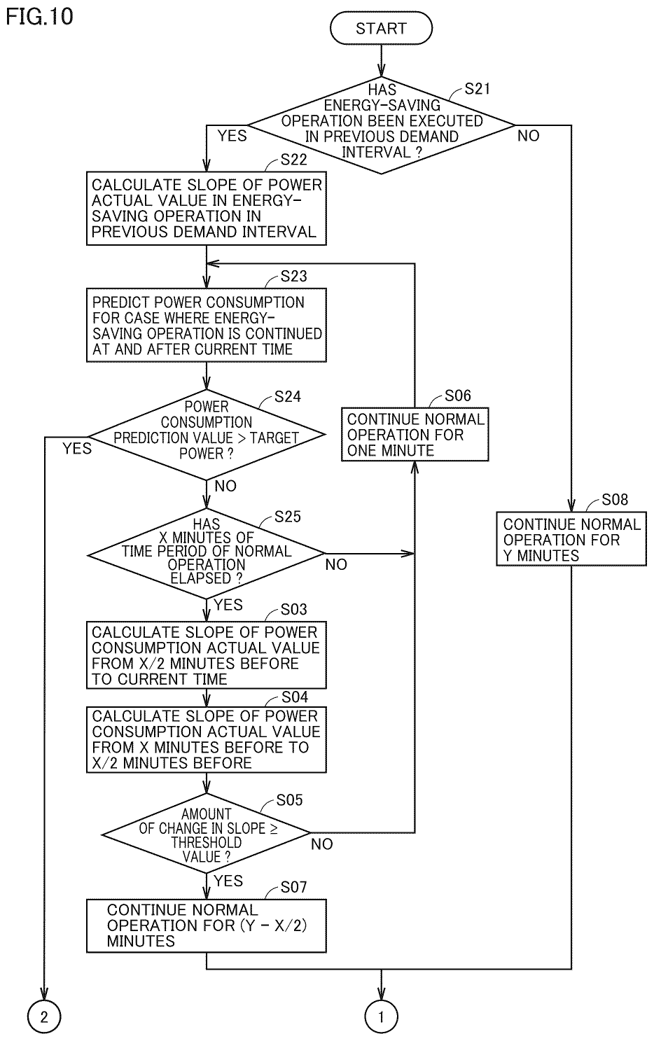

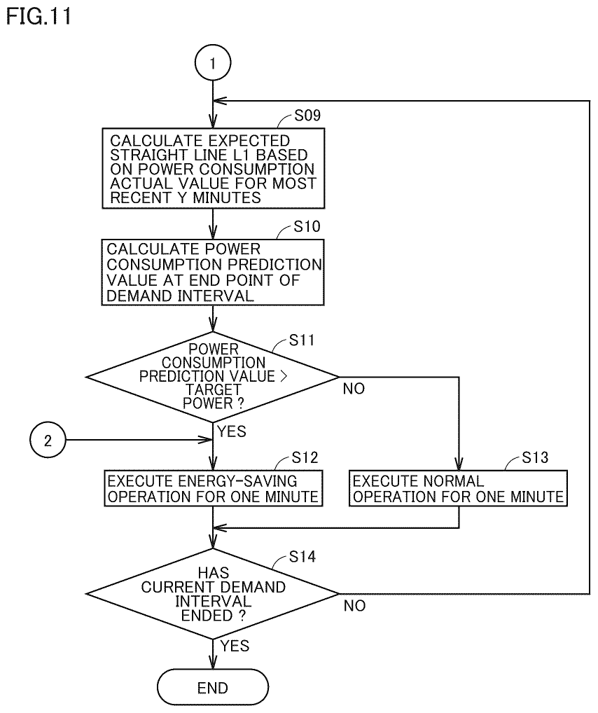

FIGS. 10 and 11 each are a flowchart illustrating an example of a process procedure for demand control by power management system 100 according to the second embodiment. The processes illustrated in the flowcharts shown in FIGS. 10 and 11 are repeatedly performed by server 1 and controllers 30, 40, and 50 in each demand interval Td. Thus, the start point (start) of the flowchart corresponds to the start point of demand interval Td.

The flowcharts shown in FIGS. 10 and 11 are obtained by adding the processes in S21 to S25 to the flowchart shown in FIG. 6.

Referring to FIG. 10, when counting of current demand interval Td is started, target power achievement determination unit 22 first determines whether or not the energy-saving operation has been executed in previous demand interval Td (S21). In S21, target power achievement determination unit 22 refers to the details about control for the electrical device in previous demand interval Td that are stored in control history storage unit 20 to determine whether or not the energy-saving operation has been executed in previous demand interval Td. When the energy-saving operation has not been executed in previous demand interval Td (determined as NO in S21), device control unit 18 executes the normal operation of the electrical device for Y minutes (S08).

On the other hand, when the energy-saving operation has been executed in previous demand interval Td (determined as YES in S21), target power achievement determination unit 22 reads the power consumption actual value in the energy-saving operation in previous demand interval Td that is stored in power actual value storage unit 4. Target power achievement determination unit 22 determines approximate straight line L2 (see FIG. 9) by linearly approximating the read power consumption actual values by the least-squares method (S22). The slope of approximate straight line L2 represents a temporal change rate (slope) of the power consumption actual value in the energy-saving operation.

Then, target power achievement determination unit 22 uses approximate straight line L2 to calculate the power consumption prediction value for the case where the execution of the energy-saving operation is continued at and after the current time (S23). From the calculated power consumption prediction value, target power achievement determination unit 22 calculates the power consumption prediction value at the end point of current demand interval Td.

Target power achievement determination unit 22 compares the power consumption prediction value at the end point of demand interval Td with the target power (S24). When the power consumption prediction value is greater than the target power (determined as YES in S24), target power achievement determination unit 22 determines that the integrated value of the power consumption within current demand interval Td may exceed the target power due to execution of the normal operation. In this case, device control unit 18 proceeds the process to S12, and executes the energy-saving operation of the electrical device for one minute (S12). This one minute corresponds to the sampling timing of demand power meter 60.

On the other hand, when the power consumption prediction value at the end point of demand interval Td is equal to or less than the target power (determined as NO in S24), target power achievement determination unit 22 determines that the integrated value of the power consumption can be set to be equal to or less than the target power even when the normal operation is executed within current demand interval Td. In this case, target power achievement determination unit 22 is assumed to execute the normal operation in current demand interval Td. However, during execution of the normal operation, at each sampling timing, target power achievement determination unit 22 calculates the power consumption prediction value for the case where the energy-saving operation is executed at the current time, and then, determines whether or not the calculated power consumption prediction value exceeds the target power by the end point of current demand interval Td.

Specifically, device control unit 18 determines whether or not X minutes of the execution time period of the normal operation in current demand interval Td has elapsed (S25). When the execution time period of the normal operation is less than X minutes (determined as NO in S25), device control unit 18 executes the normal operation of the electrical device for one minute (S06). Then, the process is returned to S23, and target power achievement determination unit 22 again uses approximate straight line L2 (see FIG. 9) to calculate the power consumption prediction value for the case where the execution of the energy-saving operation is continued at and after the current time, and then, compares the power consumption prediction value at the end point of demand interval Td with the target power (S24). When the power consumption prediction value at the end point of demand interval Td is greater than the target power (determined as YES in S24), device control unit 18 stops the execution of the normal operation and executes the energy-saving operation of the electrical device for one minute (S12).

On the other hand, when the power consumption prediction value at the end point of demand interval Td is equal to or less than the target power (determined as NO in S24), device control unit 18 returns the process to S25 and determines whether or not X minutes of the execution time period of the normal operation in current demand interval Td has elapsed (S25). The processes in S23 to S25 and S06 are repeatedly performed until X minutes of the execution time period of the normal operation elapses (determined as YES in S25).

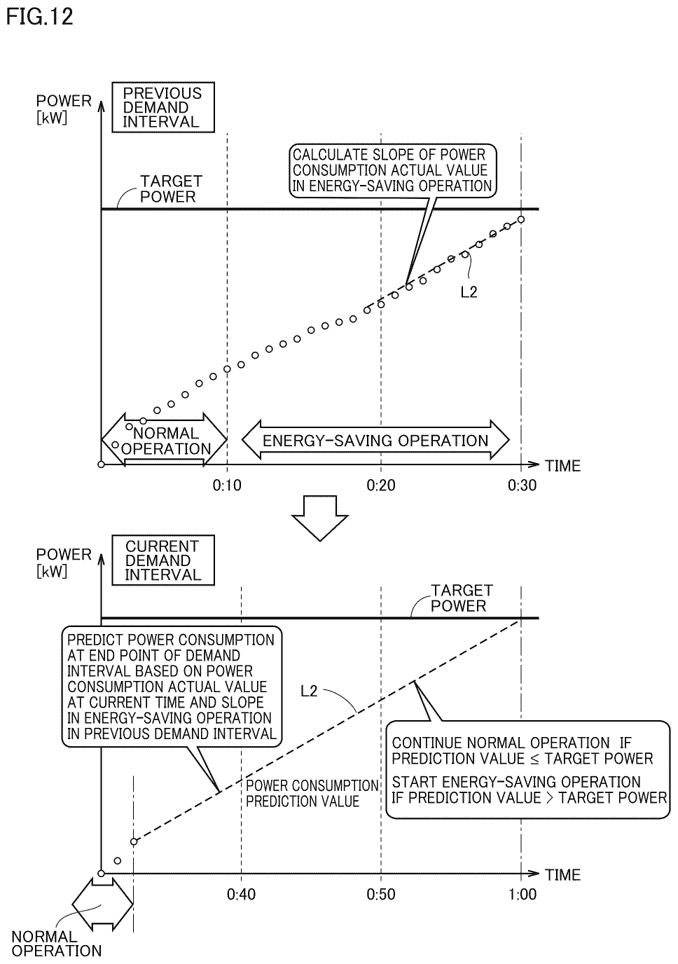

FIG. 12 is a diagram illustrating processes in S23 to S25 and S06 in FIG. 10. FIG. 12 illustrates a change in the integrated value of the power consumption in each of previous demand interval Td and current demand interval Td. In the graph in FIG. 12, the vertical axis represents power [kW] and the horizontal axis represents time.

As shown in FIG. 12, in current demand interval Td, each time the normal operation is executed for one minute, target power achievement determination unit 22 uses approximate straight line L2 to calculate the power consumption prediction value for the case where the execution of the energy-saving operation is continued at and after the current time (S23). When the power consumption prediction value at the end point of demand interval Td is greater than the target power (determined as YES in S24), target power achievement determination unit 22 determines that the integrated value of the power consumption may exceed the target power due to continuous execution of the normal operation. In response to this result of determination, device control unit 18 stops the execution of the normal operation and shifts the operation of the electrical device to the energy-saving operation.

On the other hand, when the power consumption prediction value at the end point of demand interval Td is equal to or less than the target power (determined as NO in S24), target power achievement determination unit 22 continues the execution of the normal operation for further one minute (S06), and again uses approximate straight line L2 to calculate the power consumption prediction value for the case where the execution of the energy-saving operation is continued at and after the current time (S23).

In this way, during execution of the normal operation, target power achievement determination unit 22 uses approximate straight line L2 determined from the power consumption actual value in the execution time period of the energy-saving operation within previous demand interval Td to determine whether or not the integrated value of the power consumption for the case of execution of the energy-saving operation at and after the current time exceeds the target power. When target power achievement determination unit 22 stops the execution of the normal operation based on the result of determination, the execution time period of the normal operation is substantially limited. Thereby, the power consumption actual value within demand interval Td can be reliably set to be equal to or less than the target power.

Returning to FIG. 10, when X minutes of the execution time period of the normal operation has elapsed (determined as YES in S25), comfort restoration determination unit 14 executes the same processes in S03 to S06 as those in FIG. 6 to determine whether or not the user's comfort has been restored based on the power consumption actual value in execution of the normal operation that is stored in power actual value storage unit 4.

Specifically, comfort restoration determination unit 14 linearly approximates the power consumption actual values for the time period (X/2 minutes) from X/2 minutes before to the current time, and calculates the slope of the obtained approximate straight line (S03). Further, comfort restoration determination unit 14 linearly approximates the power consumption actual values for the time period (X/2 minutes) from X minutes before to X/2 minutes before, and calculates the slope of the obtained approximate curve (S04).

Then, comfort restoration determination unit 14 calculates the amount of change between: the slope of the approximate straight line in the time period from X/2 minutes before to the current time that has been calculated in S03; and the slope of the approximate straight line in the time period from X minutes before to X/2 minutes before that has been calculated in S04, and then, compares the calculated amount of change in the slope with a threshold value (S05).

When the amount of change in the slope is less than the threshold value (determined as NO in S05), comfort restoration determination unit 14 determines that the user's comfort has not been restored. In this case, device control unit 18 executes the normal operation for further one minute (S06). Then, the process is returned to S23. Target power achievement determination unit 22 again uses approximate straight line L2 (see FIG. 9) to calculate the power consumption prediction value for the case where the execution of the energy-saving operation is continued at and after the current time, and then, compares the calculated power consumption prediction value with the target power. When the power consumption prediction value at the end point of demand interval Td is greater than the target power (determined as YES in S24), device control unit 18 stops the execution of the normal operation and executes the energy-saving operation of the electrical device for one minute (S12).

On the other hand, when the power consumption prediction value at the end point of demand interval Td is equal to or less than the target power (determined as NO in S24), the processes in S25 to S05 are executed again to determine whether or not the user's comfort has been restored based on the power consumption actual value in execution of the normal operation that is stored in power actual value storage unit 4.

When it is determined that the user's comfort has not been restored (determined as NO in S05), device control unit 18 executes the normal operation for further one minute (S06). Thereafter, comfort restoration determination unit 14 again executes the determination process (S23 to S05).

On the other hand, when it is determined that the user's comfort has been restored (determined as YES in S05), device control unit 18 executes the normal operation for further (Y−X/2) minutes (S07).

Then, energy-saving operation execution determination unit 8 determines whether or not to execute the energy-saving operation at and after the current time. First, power consumption prediction unit 6 calculates expected straight line L1 (see FIG. 7) based on the power consumption actual value for the most recent Y minutes that is stored in power actual value storage unit 4 (S09). Expected straight line L1 represents the power consumption prediction value for the case where the control for the electrical device for the most recent Y minutes is continued also at and after the current time.

Energy-saving operation execution determination unit 8 calculates the power consumption prediction value at the end point of demand interval Td based on expected straight line L1 calculated in S09 (S10), and then, compares the calculated power consumption prediction value with the target power (S11).

When the power consumption prediction value at the end point of demand interval Td is greater than the target power (determined as YES in S11), energy-saving operation execution determination unit 8 determines to execute the energy-saving operation. In this case, device control unit 18 executes the energy-saving operation of the electrical device for one minute (S12).

On the other hand, when the power consumption prediction value at the end point of demand interval Td is equal to or less than the target power (determined as NO in S11), energy-saving operation execution determination unit 8 determines not to execute the energy-saving operation. In this case, device control unit 18 executes the normal operation of the electrical device for one minute (S13).

When the energy-saving operation or the normal operation is executed for one minute, energy-saving operation execution determination unit 8 determines whether or not current demand interval Td has ended (S14). If current demand interval Td has not ended (determined as NO in S14), energy-saving operation execution determination unit 8 returns the process to S09, again calculates expected straight line L1 based on the power consumption actual value for the most recent Y minutes, and calculates the power consumption prediction value at the end point of demand interval Td based on the calculated expected straight line L1 (S10). Then, energy-saving operation execution determination unit 8 compares the power consumption prediction value at the end point of demand interval Td with the target power (S11) to determine the details about control for the next one minute (S12 and S13). The processes in S09 to S13 are repeatedly performed until it is determined that current demand interval Td has ended (determined as YES in S14).

As described above, power management system 100 according to the second embodiment uses the temporal change in the power consumption actual value in the energy-saving operation within previous demand interval Td to determine the power consumption prediction value for the case where the energy-saving operation is executed in current demand interval Td, and then, limits the execution time period of the normal operation such that the power consumption prediction value is set to be equal to or less than the target power. Thereby, the power consumption actual value within demand interval Td can be reliably set to be equal to or less than the target power.

### Third Embodiment

According to power management system 100 in the second embodiment, by limiting the execution time period of the normal operation within demand interval Td, the power consumption actual value within demand interval Td can be reliably set to be equal to or less than the target power. On the other hand, in the case where the execution time period of the normal operation necessary for calculating baseline BL cannot be ensured, the reduction effect by the demand control cannot be calculated with the use of baseline BL.

Thus, the third embodiment will be described with regard to a configuration in which baseline BL can be calculated even when the execution time period of the normal operation is limited.

### <Functional Configuration>

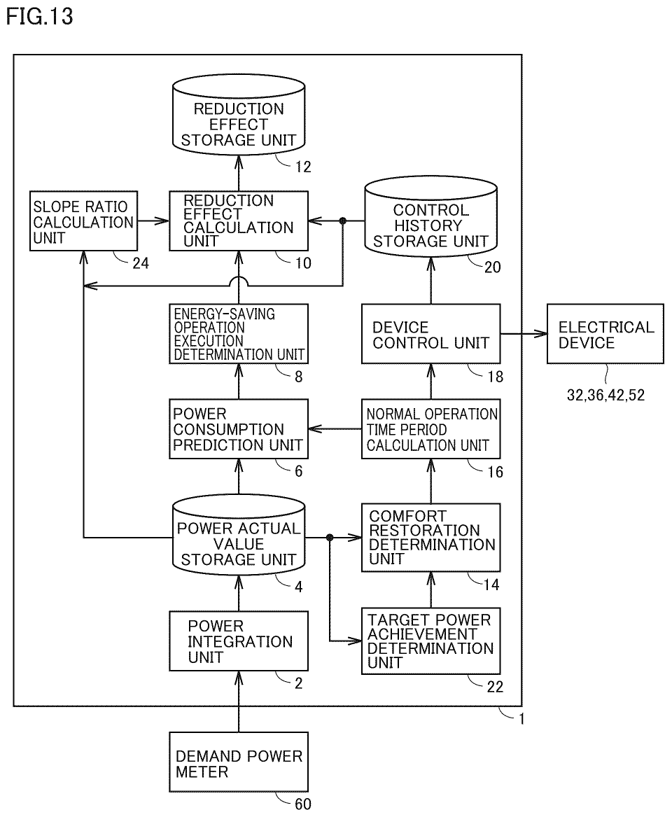

FIG. 13 is a block diagram showing a functional configuration of power management system 100 according to the third embodiment. Power management system 100 shown in FIG. 13 is obtained by adding a slope ratio calculation unit 24 to power management system 100 shown in FIG. 8.

Based on the power consumption actual value in past demand interval Td that is stored in power actual value storage unit 4 and the details about control for the electrical device in past demand interval Td that are stored in control history storage unit 20, slope ratio calculation unit 24 calculates a “slope ratio” that is a ratio in past demand interval Td between a temporal change rate (slope) of the power consumption actual value in the normal operation and a temporal change rate (slope) of the power consumption actual value in the energy-saving operation.

The power consumption by the electrical device varies depending on the environment inside a consumer facility. For example, in an air conditioner, the cooling and heating loads vary depending on the indoor temperature and/or the outdoor temperature, so that the power consumption also varies. Further, when the air conditioner controls the amount of ventilation air based on the concentration of carbon dioxide indoors, the power consumption varies according to the concentration of carbon dioxide. Under such an environment in which the power consumption by the electrical device increases, the power consumption increases not only during the normal operation but also during the energy-saving operation. Thus, the “slope ratio” in each demand interval Td tends to be constant irrespective of the magnitude of the power consumption actual value for each demand interval Td.

In the third embodiment, this tendency is utilized to acquire the “slope ratio” from the power consumption actual value in past demand interval Td, and estimate baseline BL in current demand interval Td based on the acquired “slope ratio” and the power consumption actual value in the energy-saving operation within current demand interval Td. Thereby, baseline BL can be determined even when the execution time period of the normal operation necessary for calculating baseline BL cannot be ensured.

Specifically, slope ratio calculation unit 24 refers to the details stored in control history storage unit 20 to detect past demand interval Td in which both the normal operation and the energy-saving operation have been executed. At this time, slope ratio calculation unit 24 detects past demand interval Td including the execution time period of the normal operation necessary for calculating baseline BL. When there are a plurality of corresponding demand intervals Td, slope ratio calculation unit 24 detects a prescribed number of demand intervals Td in reverse chronological order of the time at which the operations have been executed. The prescribed number may be one, or may be two or more.

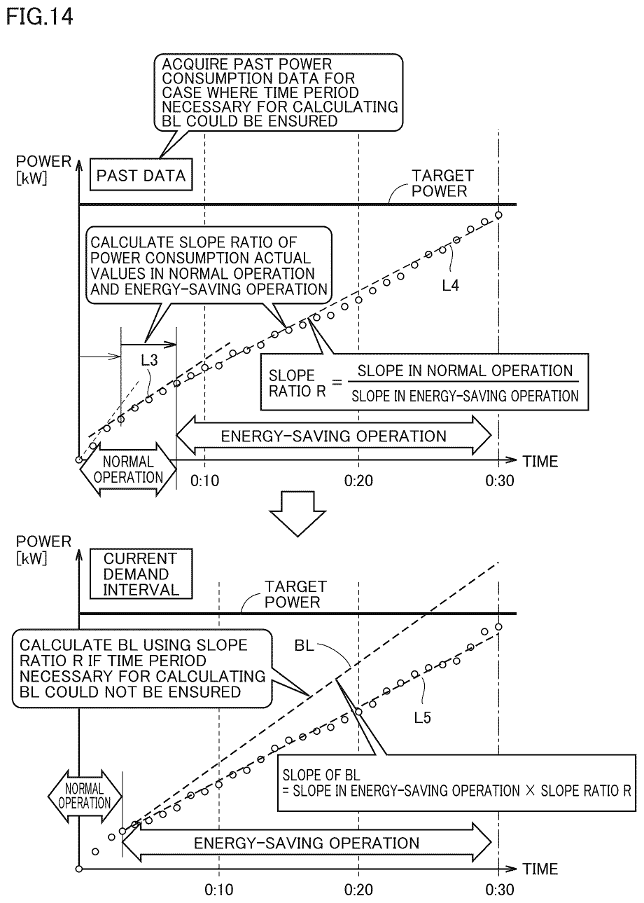

Then, slope ratio calculation unit 24 reads the power consumption actual value of the detected past demand interval Td from power actual value storage unit 4. FIG. 14 is a diagram for illustrating the operation of slope ratio calculation unit 24. FIG. 14 illustrates a change in the integrated value of the power consumption in each of past demand interval Td and current demand interval Td. In the graph in FIG. 14, the vertical axis represents power [kW] and the horizontal axis represents time.

From the data of the power consumption in past demand interval Td, slope ratio calculation unit 24 calculates:a temporal change rate (slope) of the power consumption actual value in the normal operation; and a temporal change rate (slope) of the power consumption actual value in the energy-saving operation.

As shown in FIG. 14, in the case where the execution time period of the normal operation includes the time period for restoring the user's comfort and the time period necessary for calculating baseline BL, slope ratio calculation unit 24 determines an approximate straight line L3 by linearly approximating, by the least-squares method, the data of the power consumption actual values in the time period necessary for calculating baseline BL. A slope A3 of approximate straight line L3 represents a temporal change rate (slope) of the power consumption actual value in the normal operation.

Further, slope ratio calculation unit 24 determines an approximate straight line L4 by linearly approximating the data of the power consumption actual values in the energy-saving operation by the least-squares method. A slope A4 of approximate straight line L4 represents a temporal change rate (slope) of the power consumption actual value in the energy-saving operation.

Then, slope ratio calculation unit 24 calculates a slope ratio R by dividing slope A3 of approximate straight line L3 by slope A4 of approximate straight line L4 (R=A3/A4). When a plurality of past demand intervals Td are detected, slope ratio calculation unit 24 may calculate slope ratio R for each demand interval Td, and may calculate an average value for the plurality of calculated slope ratios R.

When the execution time period of the normal operation in current demand interval Td does not include the time period necessary for calculating baseline BL, slope ratio calculation unit 24 calculates baseline BL using the calculated slope ratio R.

Specifically, slope ratio calculation unit 24 determines an approximate straight line L5 by linearly approximating the data of the power consumption actual values in the energy-saving operation within current demand interval Td by the least-squares method. A slope A5 of approximate straight line L5 represents a temporal change rate (slope) of the power consumption actual value in the energy-saving operation within current demand interval Td.

Slope ratio calculation unit 24 calculates the slope (A5×R) of baseline BL by multiplying slope A5 of approximate straight line L5 by the above-mentioned slope ratio R. Then, as shown in FIG. 14, slope ratio calculation unit 24 calculates baseline BL so as to be a straight line having a slope (A5×R) passing through the power consumption actual value at the end time of the normal operation. Baseline BL represents a power consumption prediction value for the case where the normal operation is executed for the entire time period of current demand interval Td.

Reduction effect calculation unit 10 uses the calculated baseline BL to calculate the effect of reducing the power consumption by the demand control in current demand interval Td. Specifically, reduction effect calculation unit 10 calculates the amount of power reduction resulting from execution of the demand control by subtracting the power consumption actual value at the end point of demand interval Td on baseline BL from the power consumption prediction value at this end point.

Reduction effect storage unit 12 stores the amount of power reduction calculated in each demand interval Td by reduction effect calculation unit 10.

### <Process Flow>

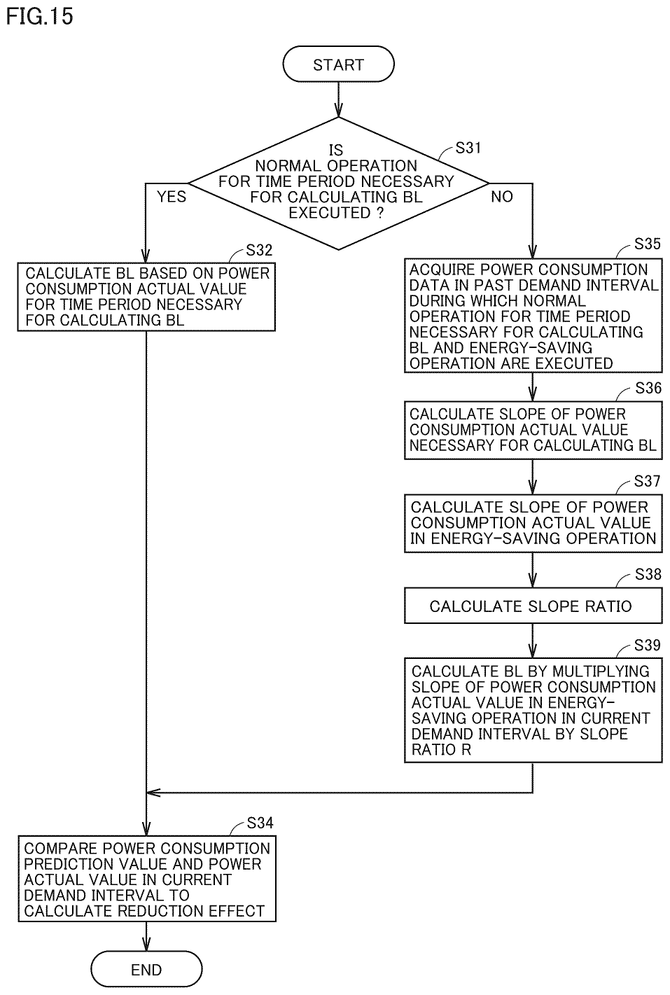

FIG. 15 is a flowchart illustrating an example of a process procedure for demand control by power management system 100 according to the third embodiment. The process shown in the flowchart in FIG. 15 is repeatedly performed by server 1 and controllers 30, 40, and 50 in each demand interval Td. In order to determine the amount of power reduction in each demand interval Td, the start point (start) of the flowchart is defined as an end point of demand interval Td.

As shown in FIG. 15, reduction effect calculation unit 10 refers to the control details stored in control history storage unit 20 to determine whether or not the execution time period of the normal operation in current demand interval Td includes the time period necessary for calculating baseline BL (S31).

For example, when the energy-saving operation is executed immediately from the start point of demand interval Td according to the result of determination by target power achievement determination unit 22, or when the normal operation is executed from the start point of demand interval Td but is switched to the energy-saving operation without waiting for restoration of the comfort, it is determined as NO in S31.

On the other hand, it is determined as YES in S31 in the case where, as a result of the operations of comfort restoration determination unit 14 and normal operation time period calculation unit 16, the normal operation is executed from the start point of demand interval Td to the time point at which the comfort is restored and the required number of power consumption actual values necessary for calculating baseline BL is acquired, or the energy-saving operation is not executed in previous demand interval Td and the normal operation is executed for the time period for acquiring the required number of power consumption actual values necessary for calculating baseline BL.

When the execution time period of the normal operation includes the time period necessary for calculating baseline BL (determined as YES in S31), power consumption prediction unit 6 calculates baseline BL based on the power consumption actual value for this time period that is stored in power actual value storage unit 4 (S32).

Reduction effect calculation unit 10 calculates the effect of reducing the power consumption by the demand control in current demand interval Td (S34). Reduction effect calculation unit 10 calculates the amount of power reduction resulting from the execution of the demand control by subtracting the power consumption actual value at the end point of demand interval Td on baseline BL calculated in S32 from the power consumption prediction value at this end point. Reduction effect storage unit 12 stores the amount of power reduction calculated in each demand interval Td by reduction effect calculation unit 10.

Returning to S31, when the execution time period of the normal operation does not include the time period necessary for calculating baseline BL (determined as NO in S31), slope ratio calculation unit 24 calculates the slope ratio in past demand interval Td based on the power consumption actual value in past demand interval Td that is stored in power actual value storage unit 4 and the details about control for the electrical device in past demand interval Td that are stored in control history storage unit 20.

Specifically, slope ratio calculation unit 24 first acquires the power consumption data in past demand interval Td that includes the execution time period of the normal operation and the execution time period of the energy-saving operation, in which the execution time period of the normal operation includes the time period necessary for calculating baseline BL (S35).

Then, from the data of the power consumption in past demand interval Td that has been acquired in S35, slope ratio calculation unit 24 calculates a temporal change rate (slope) of the power consumption actual value in the normal operation (S36). In S36, slope ratio calculation unit 24 determines approximate straight line L3 (see FIG. 14) by linearly approximating, by the least-squares method, the data of the power consumption actual values in the time period necessary for calculating baseline BL.

Then, from the data of the power consumption in past demand interval Td that has been detected in S35, slope ratio calculation unit 24 calculates a temporal change rate (slope) of the power consumption actual value in the energy-saving operation (S37). In S37, slope ratio calculation unit 24 determines approximate straight line L4 (see FIG. 14) by linearly approximating the data of the power consumption actual values in the energy-saving operation by the least-squares method.

Then, slope ratio calculation unit 24 calculates slope ratio R by dividing slope A3 of approximate straight line L3 by slope A4 of approximate straight line L4 (S38). Then, slope ratio calculation unit 24 calculates baseline BL using the calculated slope ratio R (S39). In S39, slope ratio calculation unit 24 determines approximate straight line L5 (see FIG. 14) by linearly approximating the data of the power consumption actual values in the execution time period of the energy-saving operation within current demand interval Td by the least-squares method. Then, slope ratio calculation unit 24 calculates baseline BL by multiplying the slope of the calculated approximate straight line L5 by slope ratio R calculated in S38.

Reduction effect calculation unit 10 calculates the amount of power reduction resulting from the execution of the demand control by subtracting the power consumption actual value at the end point of demand interval Td on baseline BL calculated in S39 from the power consumption prediction value at this end point (S34). Reduction effect storage unit 12 stores the amount of power reduction calculated in each demand interval Td by reduction effect calculation unit 10.

As described above, according to power management system 100 in the third embodiment, baseline BL can be estimated from the power consumption actual value in the energy-saving operation within current demand interval Td by using the “slope ratio” that is a ratio in past demand interval Td between the temporal change rate (slope) of the power consumption actual value in the normal operation and the temporal change rate (slope) of the power consumption actual value in the energy-saving operation. Thereby, even when the execution time period of the normal operation necessary for calculating baseline BL cannot be ensured within demand interval Td, baseline BL can be determined, and thus, the reduction effect by the demand control can be calculated.

### Fourth Embodiment

According to power management system 100 in the second embodiment, the power consumption actual value within demand interval Td can be reliably set to be equal to or less than the target power by limiting the execution time period of the normal operation within demand interval Td. On the other hand, when the execution time period of the normal operation for restoring the comfort cannot be ensured, there is a concern that the user's comfort may be impaired.

Thus, the fourth embodiment will be described with regard to a configuration for reliably setting the power consumption actual value within demand interval Td to be equal to or less than the target power while maintaining the user's comfort.

### <Functional Configuration>

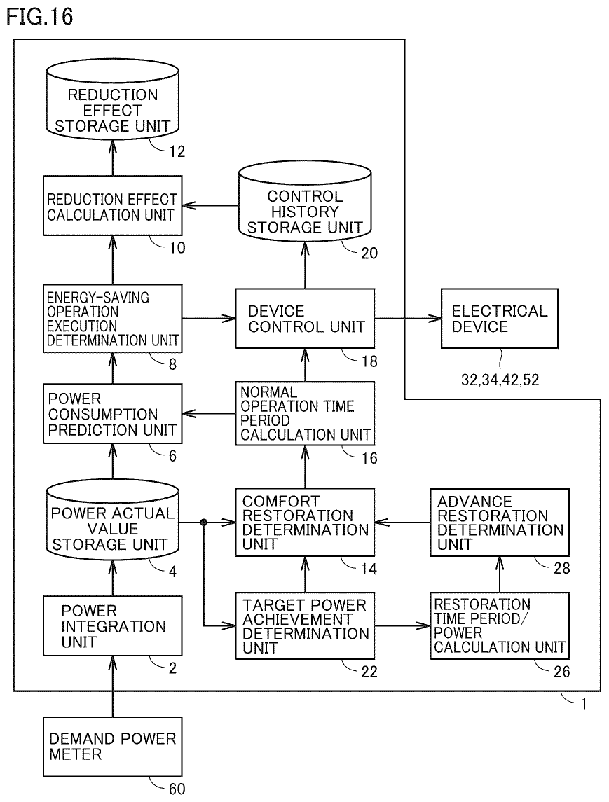

FIG. 16 is a block diagram showing a functional configuration of power management system 100 according to the fourth embodiment. Power management system 100 shown in FIG. 16 is obtained by adding a restoration time period/power calculation unit 26 and an advance restoration determination unit 28 to power management system 100 shown in FIG. 8.

Restoration time period/power calculation unit 26 calculates the time period taken for restoring the comfort and the power consumption actual value based on the power consumption data in past demand interval Td during which the normal operation for restoring the comfort and the normal operation for calculating baseline BL have been executed.

With the use of the power consumption actual value and the execution time period of the normal operation for restoring the comfort that have been calculated by restoration time period/power calculation unit 26, advance restoration determination unit 28 determines whether or not the normal operation to be executed in next demand interval Td can be executed in advance in current demand interval Td.

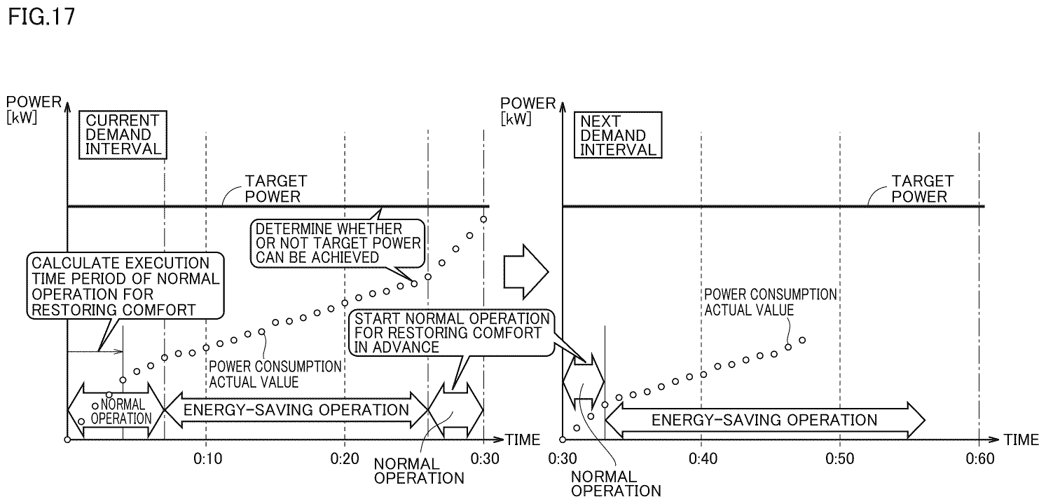

FIG. 17 is a diagram for illustrating operations of restoration time period/power calculation unit 26 and advance restoration determination unit 28. FIG. 17 illustrates a change in the integrated value of the power consumption in each of current demand interval Td and next demand interval Td. In the graph in FIG. 17, the vertical axis represents power [kW] and the horizontal axis represents time.

As shown in FIG. 17, in current demand interval Td, it is assumed that the energy-saving operation is executed after execution of the normal operation for restoring the comfort and the normal operation for calculating baseline BL.

From power actual value storage unit 4, restoration time period/power calculation unit 26 reads the power consumption data in past demand interval Td during which the normal operation for restoring the comfort has been executed. The power consumption data in past demand interval Td includes power consumption data in a plurality of demand intervals Td. The power consumption data in current demand interval Td may be included in the power consumption data in past demand interval Td.

From the power consumption data that has been read, restoration time period/power calculation unit 26 extracts data about the power consumption actual value and the execution time period of the normal operation for restoring comfort in each demand interval Td. Restoration time period/power calculation unit 26 further extracts data of the power consumption actual value in the normal operation for calculating baseline BL, in each demand interval Td.

Then, from the extracted data, restoration time period/power calculation unit 26 calculates an average value for the execution time period of the normal operation for restoring the comfort. Further, restoration time period/power calculation unit 26 calculates an average value for the temporal change rate (slope) of the power consumption actual value in the normal operation for restoring the comfort.

Further, restoration time period/power calculation unit 26 calculates an average value for the temporal change rate (slope) of the power consumption actual value in the normal operation for calculating baseline BL. Restoration time period/power calculation unit 26 outputs the calculation result to advance restoration determination unit 28.

During execution of the energy-saving operation, at each sampling timing, advance restoration determination unit 28 determines whether or not the normal operation can be executed in a time period from the current time to the end point of demand interval Td (hereinafter also referred to as a “remaining time period”).

Specifically, advance restoration determination unit 28 assumes a case where the integrated value of the power consumption changes according to the average value for the slope of the power consumption actual value in the normal operation in the remaining time period within current demand interval Td.

At this time, when the remaining time period is equal to or less than the average value for the execution time period of the normal operation for restoring the comfort, advance restoration determination unit 28 assumes that the normal operation for restoring the comfort is executed for the entire time period of this remaining time period. In this case, advance restoration determination unit 28 predicts that the integrated value of the power consumption may change in the remaining time period according to the average value for the slope of the power consumption actual value in the normal operation for restoring the comfort. When the prediction value of the integrated value of the power consumption (the power consumption prediction value) does not exceed the target power by the end point of current demand interval Td, advance restoration determination unit 28 determines that the normal operation to be executed in next demand interval Td can be executed in advance in current demand interval Td. On the other hand, when the power consumption prediction value exceeds the target power by the end point of current demand interval Td, advance restoration determination unit 28 determines that the normal operation to be executed in next demand interval Td cannot be executed in advance in current demand interval Td.

When the remaining time period is longer than the average value for the execution time period of the normal operation for restoring the comfort, advance restoration determination unit 28 assumes that the normal operation for restoring the comfort and the normal operation for calculating baseline BL are executed in the remaining time period. In this case, advance restoration determination unit 28 predicts that, in the remaining time period, the integrated value of the power consumption may change according to the average value for the slope of the power consumption actual value in the normal operation for restoring the comfort, and subsequently, the integrated value of the power consumption may change according to the average value for the slope of the power consumption actual value in the normal operation for calculating baseline BL. When the power consumption prediction value does not exceed the target power by the end point of current demand interval Td, advance restoration determination unit 28 determines that the normal operation to be executed in next demand interval Td can be executed in advance in current demand interval Td. On the other hand, when the power consumption prediction value exceeds the target power by the end point of current demand interval Td, advance restoration determination unit 28 determines that the normal operation to be executed in next demand interval Td cannot be executed in advance in current demand interval Td.

In FIG. 17, after the execution of the energy-saving operation, the normal operation for restoring the comfort is executed in advance. Thus, even when the execution time period of the normal operation is limited by target power achievement determination unit 22 in next demand interval Td, the user's comfort can be restored.

### <Process Flow>

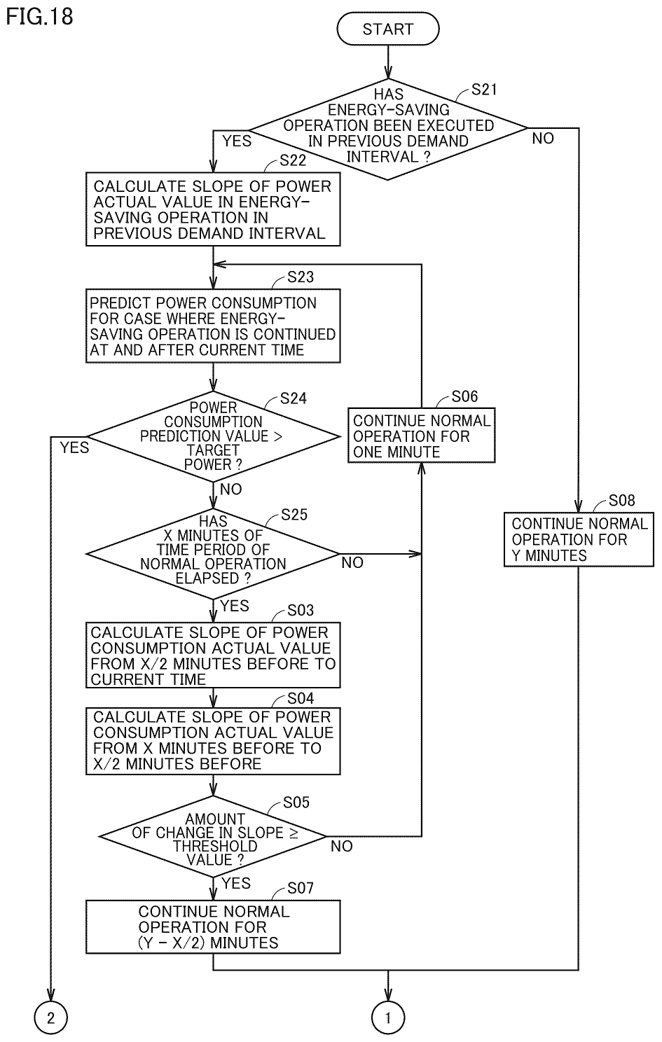

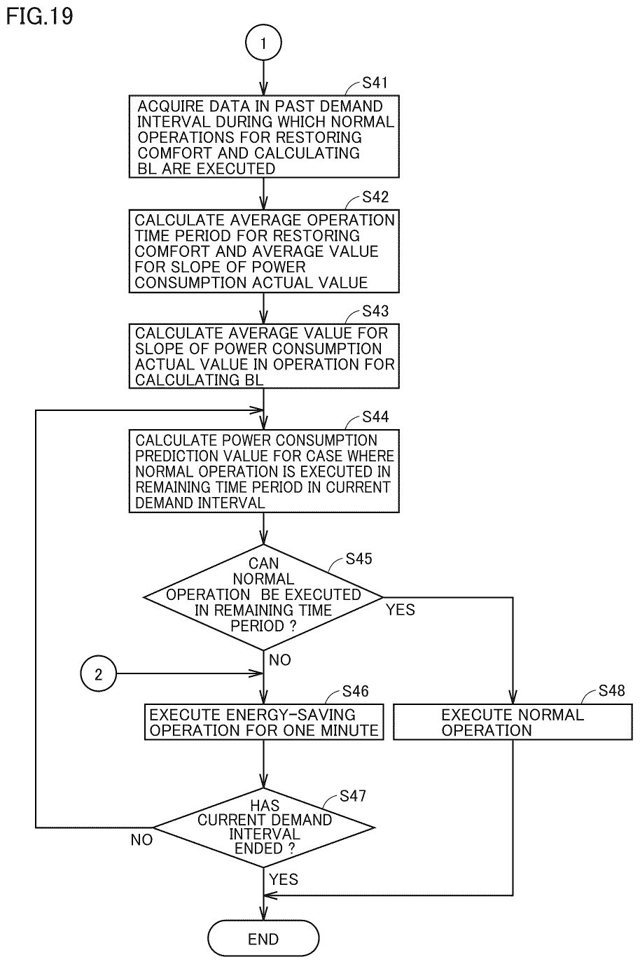

FIGS. 18 and 19 each are a flowchart illustrating an example of a process procedure for demand control by power management system 100 according to the fourth embodiment. The processes shown in the flowcharts in FIGS. 18 and 19 are repeatedly performed by server 1 and controllers 30, 40, and 50 in each demand interval Td. Thus, the start point (start) of the flowchart corresponds to the start point of demand interval Td.

The flowcharts shown in FIGS. 18 and 19 are obtained by replacing the processes in S09 to S14 in the flowchart shown in FIG. 6 with the processes in S41 to S47.

When the normal operation for restoring the comfort and calculating baseline BL is executed in S07 as in FIG. 10, or when the normal operation for calculating baseline BL is executed in S08, restoration time period/power calculation unit 26 acquires the power consumption data in past demand interval Td during which the normal operation for restoring the comfort and the normal operation for calculating baseline BL have been executed (S41).

Restoration time period/power calculation unit 26 calculates: an average value for the execution time period of the normal operation for restoring comfort; and an average value for the temporal change rate (slope) of the power consumption actual value in the normal operation (S42). Further, restoration time period/power calculation unit 26 calculates the average value for the temporal change rate (slope) of the power consumption actual value in the normal operation for calculating baseline BL (S43).

Then, advance restoration determination unit 28 calculates the power consumption prediction value for the case where the normal operation is executed in the remaining time period within current demand interval Td (S44). In S44, when the length of the remaining time period is equal to or less than the average value for the execution time period of the normal operation for restoring the comfort that has been obtained in S42, advance restoration determination unit 28 calculates the power consumption prediction value in the remaining time period with the use of the average value for the temporal change rate (slope) of the power consumption actual value in the normal operation for restoring the comfort. If the length of the remaining time period is longer than the average value for the execution time period of the normal operation for restoring the comfort that has been obtained in S42, advance restoration determination unit 28 calculates the power consumption prediction value in the remaining time period with the use of: the average value for the temporal change rate (slope) of the power consumption actual value in the normal operation for restoring the comfort; and the average value for the temporal change rate (slope) of the power consumption actual value in the normal operation for calculating baseline BL.

Advance restoration determination unit 28 compares the calculated power consumption prediction value with the target power to determine whether or not the normal operation can be executed in the remaining time period (S45). When the power consumption prediction value in the remaining time period does not exceed the target power, advance restoration determination unit 28 determines that the normal operation can be executed in the remaining time period (determined as YES in S45). In this case, device control unit 18 executes the normal operation of the electrical device (S48).

On the other hand, when the power consumption prediction value in the remaining time period exceeds the target power, advance restoration determination unit 28 determines that the normal operation cannot be executed in the remaining time period (determined as NO in S45). In this case, device control unit 18 executes the energy-saving operation of the electrical device for one minute (S46). This one minute corresponds to the sampling timing of demand power meter 60.

When the energy-saving operation is executed for one minute in S46, advance restoration determination unit 28 determines whether or not current demand interval Td has ended (S47). When current demand interval Td has not ended (determined as NO in S47), advance restoration determination unit 28 returns the process to S44, and determines again whether or not the normal operation can be executed in the remaining time period from the current time to the end point of demand interval Td. Device control unit 18 executes the normal operation (S48) or the energy-saving operation (S46) according to the result of determination by advance restoration determination unit 28. The processes in S44 to S48 are repeatedly performed until it is determined that current demand interval Td has ended (determined as YES in S47) each time the energy-saving operation is executed for one minute in S46.

As described above, according to power management system 100 in the fourth embodiment, the normal operation to be executed in next demand interval Td is executed in advance on condition that the power consumption actual value does not exceed the target power in current demand interval Td, and thereby, the user's comfort can be restored even when the execution time period of the normal operation is limited in next demand interval Td.

As to the embodiments described above, it is initially intended at the time of filing of the present application to appropriately combine the configurations described in the embodiments, including any combination not mentioned in the present specification, within a range free of inconsistency or contradiction.

It should be understood that the embodiments disclosed herein are illustrative and non-restrictive in every respect. The technical scope described in the present disclosure is defined by the terms of the claims, rather than the above description of the embodiments, and is intended to include any modifications within the meaning and scope equivalent to the terms of the claims.

### REFERENCE SIGNS LIST

1 server, 2 power integration unit, 4 power actual value storage unit, 6 power consumption prediction unit, 8 energy-saving operation execution determination unit, 10 reduction effect calculation unit, 12 reduction effect storage unit, 14 comfort restoration determination unit, 16 normal operation time period calculation unit, 18 device control unit, 20 control history storage unit, 22 target power achievement determination unit, 24 slope ratio calculation unit, 26 restoration time period/power calculation unit, 28 advance restoration determination unit, 30, 40, 50 controller, 32, 36, 42, 52 electrical device, 34, 38, 44, 46, 54 sensor, 60 demand power meter, 100 power management system, 102 CPU, 104 ROM, 106 RAM, 108 I/F device, 110 storage device, 112 communication bus, BL baseline, L1 expected straight line, L2 to L5 approximate straight line, R slope ratio, Td demand interval.

1. A power management system that manages power consumption in a consumer facility, the power management system comprising:
a processor;
a memory to store a program executed by the processor; and
a power meter to measure power consumption in an entirety of the consumer facility, wherein
according to the program, the processor is configured to
calculate a power consumption integrated value in a demand interval based on a measurement value of the power meter, and
execute demand control for controlling an electrical device in the consumer facility such that the power consumption integrated value in the demand interval does not exceed target power, and
in the demand control, the processor
executes a normal operation of the electrical device from a start point of the demand interval,
based on a temporal change in the power consumption integrated value in execution of the normal operation, determines whether or not comfort for a user of the consumer facility has been restored,
from a time at which the comfort has been restored, sets an execution time period of the normal operation so as to ensure a time period necessary for calculating a baseline, the baseline being a prediction value of the power consumption integrated value for a case where the normal operation is executed for an entire time period of the demand interval, and
when the baseline exceeds the target power by an end point of the demand interval, shifts the normal operation to an energy-saving operation in which the power consumption by the electrical device is more suppressed than in the normal operation.

2. The power management system according to claim 1, wherein the processor determines that the comfort has been restored when the temporal change in the power consumption integrated value in execution of the normal operation becomes gradual.

3. The power management system according to claim 1, wherein the processor calculates the baseline based on the power consumption integrated value in execution of the normal operation at and after a time at which the comfort has been restored.

4. The power management system according to claim 1, wherein
during execution of the normal operation, at each sampling timing of the power meter, the processor calculates a prediction value of the power consumption integrated value for a case where the energy-saving operation is executed at and after a current time, based on a temporal change in the power consumption integrated value in execution of the energy-saving operation within a previous demand interval, and
the processor limits the execution time period of the normal operation by shifting the normal operation to the energy-saving operation when the prediction value exceeds the target power by the end point of the demand interval.

5. The power management system according to claim 4, wherein
at the start point of the demand interval, based on the temporal change in the power consumption integrated value in execution of the energy-saving operation within the previous demand interval, the processor calculates a prediction value of the power consumption integrated value for a case where the energy-saving operation is executed for the entire time period of the demand interval, and
the processor sets the execution time period of the normal operation at zero when the prediction value exceeds the target power by the end point of the demand interval.

6. The power management system according to claim 4, wherein
the processor calculates a slope ratio based on the power consumption integrated value in a past demand interval, the slope ratio being a ratio between a temporal change rate of the power consumption integrated value in execution of the normal operation and a temporal change rate of the power consumption integrated value in execution of the energy-saving operation,
when the execution time period of the normal operation in a current demand interval is limited, the processor calculates the baseline by multiplying the temporal change rate of the power consumption integrated value in execution of the energy-saving operation by the slope ratio, and
the processor calculates an amount of power reduction resulting from execution of the demand control by subtracting the power consumption integrated value at the end point of the demand interval on the baseline from the prediction value at the end point.

7. The power management system according to claim 4, wherein
from power consumption data in a past demand interval, the processor calculates an average value for the execution time period of the normal operation for restoring the comfort and an average value for a temporal change rate of the power consumption integrated value,
during execution of the energy-saving operation, with use of the calculated average values, the processor calculates a prediction value of the power consumption integrated value for a case where the normal operation is executed in a remaining time period within a current demand interval, and
the processor shifts the energy-saving operation to the normal operation when the prediction value in the remaining time period does not exceed the target power.

8. The power management system according to claim 7, wherein the processor continues to execute the energy-saving operation when the prediction value in the remaining time period exceeds the target power.

9. A power management method of managing power consumption in a consumer facility, the power management method comprising:
calculating a power consumption integrated value in a demand interval based on a measurement value of a power meter that measures power consumption in an entirety of the consumer facility; and
executing demand control for controlling an electrical device in the consumer facility such that the power consumption integrated value in the demand interval does not exceed target power, wherein
the executing demand control includes
executing a normal operation of the electrical device from a start point of the demand interval,
based on a temporal change in the power consumption integrated value in execution of the normal operation, determining whether or not comfort for a user of the consumer facility has been restored,
from a time at which the comfort has been restored, setting an execution time period of the normal operation so as to ensure a time period necessary for calculating a baseline, the baseline being a prediction value of the power consumption integrated value for a case where the normal operation is executed for an entire time period of the demand interval, and
when the baseline exceeds the target power by an end point of the demand interval, shifting the normal operation to an energy-saving operation in which the power consumption by the electrical device is more suppressed than in the normal operation.

10. The power management method according to claim 9, wherein the determining includes determining that the comfort has been restored when the temporal change in the power consumption integrated value in execution of the normal operation becomes gradual.

11. The power management method according to claim 9, wherein the shifting includes calculating the baseline based on the power consumption integrated value in execution of the normal operation at and after a time at which the comfort has been restored.

12. The power management method according to claim 9, wherein
the executing demand control includes
during execution of the normal operation, at each sampling timing of the power meter, calculating a prediction value of the power consumption integrated value for a case where the energy-saving operation is executed at and after a current time, based on a temporal change in the power consumption integrated value in execution of the energy-saving operation within a previous demand interval, and
limiting the execution time period of the normal operation by shifting the normal operation to the energy-saving operation when the prediction value exceeds the target power by the end point of the demand interval.

13. The power management method according to claim 12, wherein
the calculating includes, at the start point of the demand interval, based on the temporal change in the power consumption integrated value in execution of the energy-saving operation within the previous demand interval, calculating a prediction value of the power consumption integrated value for a case where the energy-saving operation is executed for the entire time period of the demand interval, and
the limiting includes setting the execution time period of the normal operation at zero when the prediction value exceeds the target power by the end point of the demand interval.

14. The power management method according to claim 12, wherein
the executing demand control includes
calculating a slope ratio based on the power consumption integrated value in a past demand interval, the slope ratio being a ratio between a temporal change rate of the power consumption integrated value in execution of the normal operation and a temporal change rate of the power consumption integrated value in execution of the energy-saving operation,
when the execution time period of the normal operation in a current demand interval is limited, calculating the baseline by multiplying the temporal change rate of the power consumption integrated value in execution of the energy-saving operation by the slope ratio, and
calculating an amount of power reduction resulting from execution of the demand control by subtracting the power consumption integrated value at the end point of the demand interval on the baseline from the prediction value at the end point.

15. The power management method according to claim 12, wherein
the executing demand control includes
from power consumption data in a past demand interval, calculating an average value for the execution time period of the normal operation for restoring the comfort for the user in the consumer facility and an average value for a temporal change rate of the power consumption integrated value,
during execution of the energy-saving operation, with use of the calculated average values, calculating a prediction value of the power consumption integrated value for a case where the normal operation is executed in a remaining time period within a current demand interval, and
shifting the energy-saving operation to the normal operation when the prediction value in the remaining time period does not exceed the target power.

16. The power management method according to claim 15, wherein the executing demand control further includes continuing to execute the energy-saving operation when the prediction value in the remaining time period exceeds the target power.
